(19) United States
(12) Patent Application Publication
(10) Pub. No.: US 2021/0337432 A1
(43) Pub. Date: Oct. 28, 2021

(54) AUTONOMOUS HANDOVER FOR WIRELESS NETWORKS

(71) Applicant: Apple Inc., Cupertino, CA (US)

(72) Inventors: Anthony LEE, San Diego, CA (US); Huaning NIU, San Jose, CA (US); Seau S. LIM, Swindon, SWD (GB)

(21) Appl. No.: 16/479,891

(22) PCT Filed: Mar. 29, 2018
(86) PCT No.: PCT/US2018/025244

§ 371 Date: Jul. 22, 2019

Related U.S. Application Data
(60) Provisional application No. 62/478,439, filed on Mar. 29, 2017.

(51) Int. Cl. H04W 36/00

(52) U.S. Cl. CPC H04W 36/0005

(57) ABSTRACT

Herein described are apparatuses, systems, and methods related to handover operations of user equipment within a wireless network. An apparatus for an evolved NodeB (eNB) may include circuitry to determine one or more candidate eNBs available to provide service to a user equipment (UE) based on cell information received from one or more other eNBs, and generate an autonomous handover (HO) information message for transmission to the UE, wherein the autonomous HO information message includes an indication of the one or more candidate eNBs. The apparatus may further include memory to store the indication of the one or more candidate eNBs. Other embodiments may be described and/or claimed.

### RELATED APPLICATIONS

The present application claims priority to U.S. Provisional Patent Application No. 62/478,439, filed Mar. 29, 2017, entitled “AUTONOMOUS UPLINK GRANT (SIGNALING ASPECT)”, the entire disclosure of which is hereby incorporated by reference.

### TECHNICAL FIELD

The present disclosure relates to the field of wireless communications. More particularly, the present disclosure relates to the handover operation of user equipment within a wireless network.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Legacy wireless networks include multiple evolved NodeBs (eNBs) to provide service for user equipment (UE) within the networks. As a UE moves locations, service for the UE is transferred among the eNBs within the networks to maintain service for the UE. A handover (HO) procedure is implemented to provide transferring of the service among the eNBs.

Legacy HO procedures include the UE transmitting a measurement report to a source eNB that is providing the service to the UE. The UE monitors for a period of time for an HO command to be received from the eNB, wherein the HO command instructs the UE to establish a connection with a target eNB. However, in some instances the HO command arrives at the UE after the period of time or the UE fails to identify the HO command. In these instances, transfer of service from the source eNB to the target eNB may not occur while the service provided by the source eNB may become inadequate or the UE may move outside of the service area of the source eNB. This can result in gaps of services to the UE, which can cause the UE to experience communication failures, such as dropping calls.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example network, according to various embodiments.

FIG. 2 illustrates a call-flow representation of an example handover procedure, according to various embodiments.

FIG. 3 illustrates a flow representation of a portion of an HO procedure, according to various embodiments.

FIG. 4 illustrates a flow representation of another portion of the example HO procedure of FIG. 3, according to various embodiments.

FIG. 5 illustrates a continuation of the flow representation of FIG. 4, according to various embodiments.

FIG. 6 illustrates an architecture of a system of a network in accordance with some embodiments.

FIG. 7 illustrates an architecture of a system of a network in accordance with some embodiments.

FIG. 8 illustrates an example of infrastructure equipment in accordance with various embodiments.

FIG. 9 illustrates an example of a platform in accordance with various embodiments.

FIG. 10 illustrates example components of baseband circuitry and radio front end modules (RFEM) in accordance with some embodiments.

FIG. 11 illustrates example interfaces of baseband circuitry in accordance with some embodiments.

FIG. 12 is an illustration of a control plane protocol stack in accordance with some embodiments.

FIG. 13 is an illustration of a user plane protocol stack in accordance with some embodiments.

FIG. 14 illustrates components of a core network in accordance with some embodiments.

FIG. 15 is a block diagram illustrating components, according to some example embodiments, able to read instructions from a machine-readable or computer-readable medium (e.g., a non-transitory machine-readable storage medium) and perform any one or more of the methodologies discussed herein.

### DETAILED DESCRIPTION

Apparatuses, systems, and methods related to handover operations of user equipment within a wireless network are disclosed herein. An apparatus for an evolved NodeB (eNB) may include circuitry to determine one or more candidate eNBs available to provide service to a user equipment (UE) based on cell information received from one or more other eNBs, and generate an autonomous handover (HO) information message for transmission to the UE, wherein the autonomous HO information message includes an indication of the one or more candidate eNBs. The apparatus may further include memory to store the indication of the one or more candidate eNBs.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an application specific integrated circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

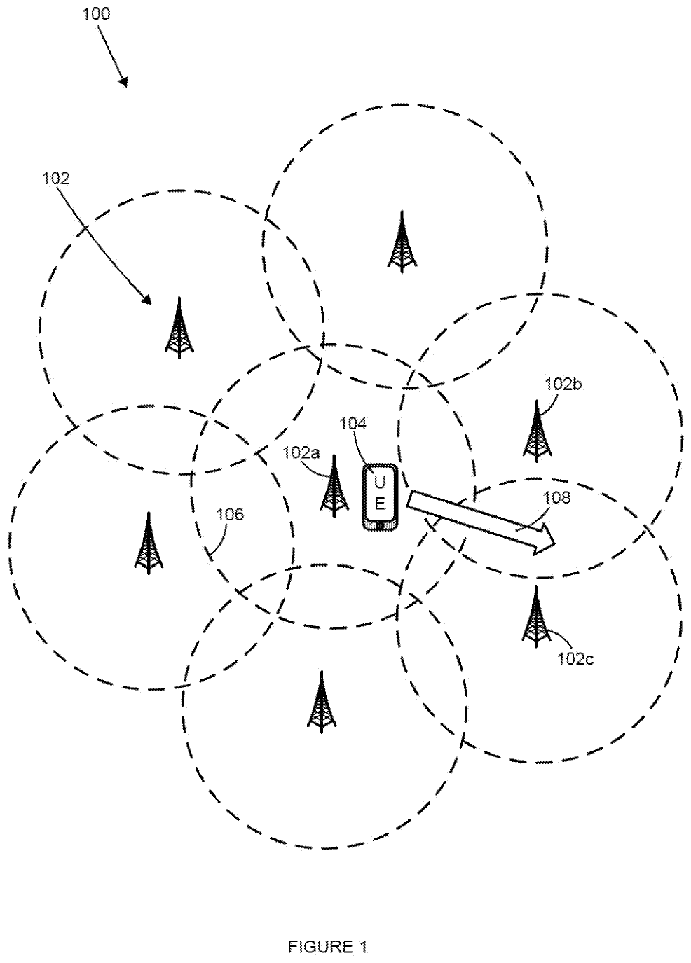

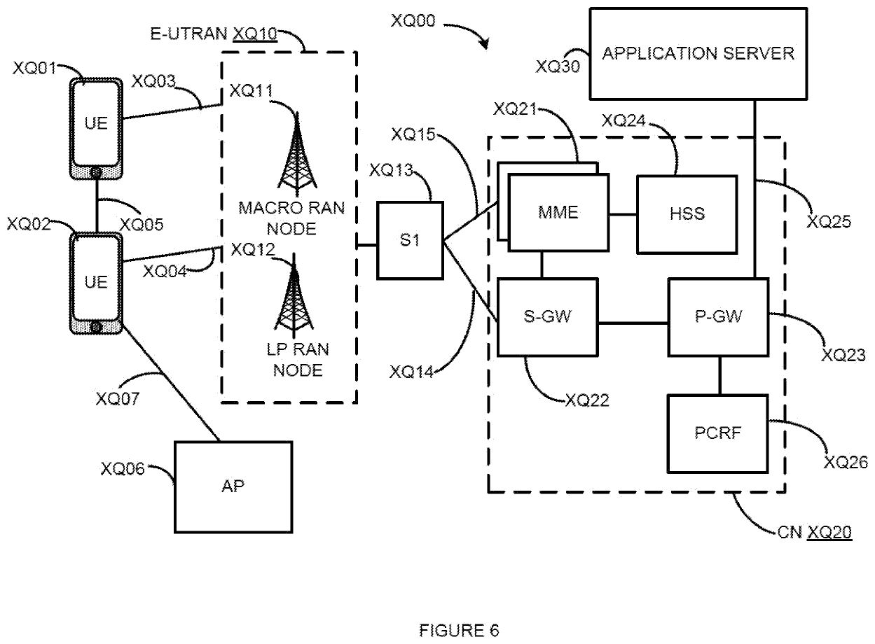

FIG. 1 illustrates an example network 100, according to various embodiments. A system of the network 100 may include one or more of the features of the system XQ00 (FIG. 6). The network 100 may include a plurality of evolved NodeB (eNBs) 102. The eNBs 102 may provide service to user equipments (UEs), located within the network 100, allowing the UEs to communicate with other elements within the network 100 and/or within other networks. Each of the eNBs 102 described herein may include one or more of the features of the RAN node XQ11 (FIG. 6) and/or the RAN node XQ12 (FIG. 6). Further, each of the UEs described herein may include one or more of the features of the UE XQ01 (FIG. 6) and/or the UE XQ02 (FIG. 6).

The eNBs 102 may be communicatively coupled to each other and may communicate information among the eNBs 102. The information communicated among the eNBs may include cell information for each, or some portion, of the eNBs 102. The cell information may include a number of UEs that are connected to each of the eNBs 102, an amount of traffic being serviced by each of the eNBs 102, identifiers of each of the eNBs 102, quality of service levels provided to the UEs connected to each of the eNBs 102, predicted quality of service levels for UEs for each of the eNBs, or some combination thereof.

The network 100 may include a plurality of UEs. Each of the UEs may connect to one or more of the eNBs 102, wherein the eNB to which a UE is connected provides service for the UE. For simplicity, a single UE 104 is illustrated and described to demonstrate the subject matter disclosed herein. In the illustrated embodiment, the UE 104 may be located within a service area 106 of first eNB 102a. Further, the UE 104 may be connected to the first eNB 102a, wherein the first eNB 102a provides service to the UE 104. The first eNB 102a may be referred to a source eNB of the UE 104 based on the connection between the first eNB 102a and the UE 104.

The first eNB 102a may receive information from the UE 104. The information may include information regarding quality of service provided, or that may be provided, to the UE 104 by the eNBs 102. For example, the UE 104 may receive signals from a portion of the eNBs 102 that are located to proximate to the UE 104 and may determine a quality of service that is, or may be, provided by the portion of the eNBs 102. The UE 104 may determine the eNB to which each of the signals corresponds, strength of each of the signals, signal-to-noise ratio of each of the signals, signal-to-interference of each of the signals, error rate of the signals, or some combination thereof.

The first eNB 102a may further determine characteristics of the UE 104. For example, the first eNB 102a may determine a location of the UE 104, a direction that the UE 104 is travelling, a speed of travel of the UE 104, or some combination thereof.

Based on the information received from the other eNBs 102, the information received from the UE 104, and/or the determined characteristics of the UE 104, the first eNB 102a may identify a portion of the other eNBs 102 that are available to provide service to the UE 104, or may be available to provide service to the UE 104 in the foreseeable future. For example, the first eNB 102a may determine that the UE 104 is moving along the path 108. The first eNB 102a may determine that a second eNB 102b and a third eNB 102c may be available to provide service to the UE 104 based on the information received from the second eNB 102b, information received from the third eNB 102c, information and/or characteristics of the UE 104, or some combination thereof. The second eNB 102b and the third eNB 102c may be referred to as candidate eNBs for the UE 104 based on their availability to provide service to the UE 104.

The first eNB 102a may generate an autonomous handover (HO) information message based on the determination of the candidate eNBs for the UE 104. The autonomous HO information message may include an indication of the candidate eNBs, such as a list of identifiers (such as a physical cell identifier and/or cell radio network temporary identifiers (C-RNTI)) of the candidate eNBs. The first eNB 102a may encode and transmit the autonomous HO information message to the UE 104. In some embodiments, the first eNB 102a may encode and transmit the autonomous HO information message only if the candidate eNBs for the UE 104 have changed from a previously transmitted autonomous HO information message, an order of the candidate eNBs within the sorted list has changed, or the first eNB 102a receives an indication to transmit the autonomous HO information message provided by the UE 104.

The UE 104 may identify and store the indication of the candidate eNBs. In some instances (as are described further throughout this disclosure), the UE 104 may perform an HO operation to establish a connection with one of the candidate eNBs. For example, the UE 104 may determine that a quality of service of the first eNB 102a is inadequate and/or one of the candidate eNBs would provide better service, and may perform the HO operation to establish a connection with the one of the candidate eNBs. As part of the HO operation, the UE 104 may terminate connection with the first eNB 102a.

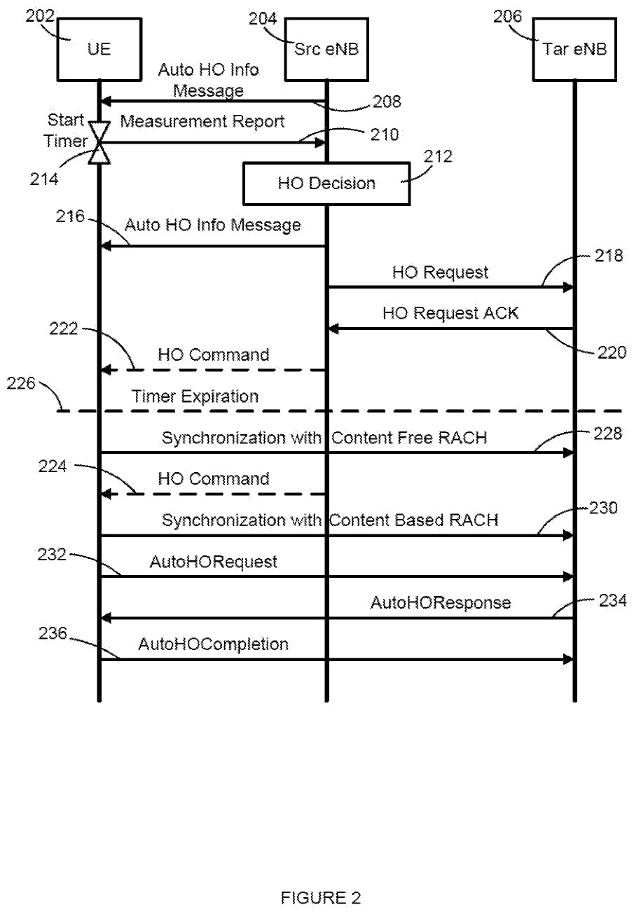

FIG. 2 illustrates a call-flow representation of an example HO procedure, according to various embodiments. The HO procedure may be performed for a system that operates in the unlicensed spectrum (such as a MulteFire system), which may implement a listen-before-talk protocol. The illustrated embodiment shows transfer of service for a UE 202 from a source eNB 204 to a target eNB 206. In particular, the UE 202 may establish a connection with the target eNB 206 and release a connection to the source eNB 204 as part of the HO procedure.

The source eNB 204 may encode and transmit an autonomous HO information message 208 to the UE 202. The autonomous HO information message 208 may include one or more of the features of the autonomous HO information message described in relation to FIG. 1. Further, generation of the autonomous HO information message 208 may include one or more features of the generation of the autonomous HO information message described in relation to FIG. 1. In particular, the source eNB 204 may identify one or more candidate eNBs for the UE 202 based on information received from one or more other eNBs, information received from the UE 202, determined characteristics of the UE 202, or some combination thereof. The source eNB 204 may generate the autonomous HO information message 208, wherein the autonomous HO information message 208 includes an indication of the candidate eNBs (which may be labeled “targetPhysCellID”). The indication of the candidate eNBs may include a list of identifiers of the candidate eNBs. In some embodiments, the list of identifiers may be a sorted list, wherein candidate eNBs that may be determined to provide better service levels may be located at higher priority positions within the list. Further, in some embodiments, the list may be limited to a maximum number of candidate eNBs, wherein candidates that provide the best service levels may be included in the list.

In some embodiments, the autonomous HO information message 208 may further include an indication of carrier frequencies for each of the candidate eNBs (which may be labeled “carrierFreq”), an indication of carrier bandwidths for each of the candidate eNBs (which may be labeled “carrierBandwidth”), an indication of radio resource configuration for each of the candidate eNBs (which may be labeled “radioResourceConfigCommon-MF”), an indication of whether the autonomous HO information message 208 is generated in response to a measurement report (which may be labeled “MeasReportAck”), or some combination thereof. As the autonomous HO information message 208 is not generated in response to a measurement report, the autonomous information message 208 may indicate that the autonomous HO information message 208 was not generated in response to the measurement report.

The UE 202 may encode and transmit a measurement report 210 to the source eNB 204. The measurement report 210 may be transmitted after reception of the autonomous HO information message 208 by the UE 202. The measurement report 210 may include an indication of connectivity information of the UE 202 with eNB located proximate to the UE 202. For example, the UE 202 may receive reference signals from eNBs that are close enough to the UE 202 for the UE 202 to detect the reference signals. The UE 202 may determine signal and/or channel qualities (such as signal-to-noise ratios, signal-to-interference ratios, and/or error rates) of the reference signals. The connectivity information may include the determined signal and/or channel qualities.

The UE 202 may initiate counting of an autonomous HO timer 214 in response to the transmission of the measurement report 210. For example, the UE 202 may initiate counting of the autonomous HO timer 214 upon transmission of the measurement report 210. The autonomous HO timer 214 may begin counting at an initial value and may count up or count down to an expiration value. In some embodiments, the measurement report 210 may include an indication of the time for the autonomous HO timer 214 to count from the initial value to the expiration value.

In response to receiving the measurement report 210, the source eNB 204 may perform an HO decision 212 to determine the UE 202 should perform an HO operation. For example, the source eNB 204 may evaluate the information received in the measurement report 210 to determine whether performing an HO operation would be beneficial to the UE 202 and/or is required to maintain an adequate level of service for the UE 202.

Further, the source eNB 204 may update the candidate eNBs for the UE 202 in response to receiving the measurement report 210. For example, the source eNB 204 may evaluate the information received in the measurement report 210 and determine candidate eNBs that are available to provide service to the UE 202 based on the information. The update of the candidate eNBs with the determined candidate eNBs may be based on the information in the measurement report 210.

The source eNB 204 may encode and transmit a second autonomous HO information message 216 to the UE 202 in response to the measurement report 210. The second autonomous HO information message 216 may include one or more of the features of the autonomous HO information message 208. The second autonomous HO information message 216 may be transmitted after the HO decision 212 or prior to the HO decision 212. The second autonomous HO information message 216 may be transmitted subsequent to the autonomous HO information message 208.

The second autonomous HO information message 216 may include an indication of the updated candidate eNBs. For example, the second autonomous HO information message 216 may include a list of identifiers of the updated candidate eNBs. The second autonomous HO information message 216 may further include an indication of carrier frequencies for each of the updated candidate eNBs (which may be labeled “carrierFreq”), an indication of carrier bandwidths for each of the updated candidate eNBs (which may be labeled “carrierBandwidth”), an indication of radio resource configuration for each of the updated candidate eNBs (which may be labeled “radioResourceConfigCommon-MF”), an indication of whether the autonomous HO information message 208 is generated in response to a measurement report (which may be labeled “MeasReportAck”), or some combination thereof. As the autonomous HO information message 208 is generated in response to the measurement report 210, the autonomous information message 208 may indicate that the autonomous HO information message 208 was generated in response to the measurement report 210.

In some embodiments, the second autonomous HO information message 216 may include an indication that the UE 202 is to restart the autonomous HO timer 214. For example, the source eNB 204 may determine that an HO command transmitted in response to the measurement report 210 will not be received by the UE prior to the expiration of the autonomous HO timer 214. The determination may be based on the indication of the time for the autonomous HO timer 214 received in the measurement report 210. Further, the second autonomous HO information message 216 may include an indication of a value from which the autonomous HO timer 214 should restart counting. In response to receiving the second autonomous HO information message 216 with the indication that the UE 202 is to restart the autonomous HO timer 214, the UE 202 may restart the counting of the timer from the initial value or from the indicated value, if second autonomous HO information message 216 includes the indicated value.

In some embodiments or instances, the second autonomous HO information message 216 may be omitted. For example, the second autonomous HO information message 216 may be omitted in instances where the source eNB 204 fails to identify the measurement report 210. Further, the second autonomous HO information message 216 may be omitted in instances where the updated candidate eNBs are the same as the candidate eNBs indicated in the autonomous HO information message 208.

In instances where the source eNB 204 determines that an HO operation is to be performed by the UE 202, the source eNB 204 may determine that the UE 202 is to perform the HO operation to connect to the target eNB 206. The source eNB 204 may transmit an HO request 218 to the target eNB 206 requesting transfer of service for the UE 202 to the target eNB 206. In response to receiving the HO request 218, the target eNB 206 may respond with an HO request acknowledgement (ACK) 220. The HO request ACK 220 may indicate whether the target eNB 206 is willing to provide service to the UE 202. In some embodiments where the target eNB 206 indicates that the target eNB is not willing to provide service to the UE 202, the source eNB 204 may repeat the HO request procedure and transmit the HO request 218 to other eNBs until one of the eNBs indicates that it is willing to provide service to the UE 202.

In response to receiving the HO request ACK 220 that indicates the target eNB 206 is willing to provide service to the UE 202, the source eNB 204 may transmit an HO command to the UE 202. The illustrated embodiment depicts a first representation 222 of the HO command and a second representation 224 of the HO command. In particular, the first representation 222 indicates that the HO command may be transmitted prior to a timer expiration 226 of the autonomous timer 214 if the HO request procedure is completed at a sufficient time prior to the timer expiration 226. The second representation 224 indicates that the HO command may be transmitted after the timer expiration 226 if the HO request procedure is not completed at the sufficient time prior to the timer expiration 226. In other embodiments, the source eNB 204 may not transmit the HO command to the UE 202 if the source eNB 204 determines that the HO command would be received after the timer expiration 226.

In instances where the HO command is received prior to the timer expiration 226, the UE 202 may perform an HO operation to connect with the target eNB 206. In particular, the HO command may indicate that the UE 202 is to perform an HO operation to connect to the target eNB 206. The UE 202 may perform synchronization with contention free random access channel (RACH) 228 or synchronization with contention-based RACH 230 to establish a connection with the target eNB 206. Further, the UE may disconnect from the source eNB 204 during the HO operation.

In instances where the HO command is received after the timer expiration 226 or the HO command is not received, the UE 202 may remain connected to the source eNB 204. In other embodiments, the UE 202 may perform an autonomous HO operation in response to the timer expiration 226 without having received the HO command from the source eNB 204. The autonomous HO operation may include selecting a target eNB from the candidate eNBs indicated in the most recent autonomous HO information message, which may be the autonomous HO information message 208 or the second autonomous HO information message 216. The UE 202 may select the target eNB randomly, based on the position of the target eNB in the sorted list of candidate eNBs, or based on the UE 202 determining that the target eNB is predicted to provide the best service of the candidate eNBs. In the illustrated embodiment, the UE 202 is illustrated as having selected the target eNB 206.

After selecting the target eNB 206 from the list of candidate eNBs, the UE 202 may encode and transmit an autonomous HO request 232 to the target eNB 206. The autonomous HO request 232 may request that the target eNB 206 allow the UE 202 to establish a connection with the target eNB 206. In response to the target eNB 206 detecting the autonomous HO request 232, the target eNB 206 may respond with an autonomous HO response 234. The autonomous HO response 234 may include an indication that target eNB 206 will allow the UE 202 to establish a connection with the target eNB 206, information regarding service specifics of the target eNB 206 (such as carrier frequency of the target eNB 206, carrier bandwidth of the target eNB 206, and/or radio resource configuration of the target eNB 206), or some combination thereof. In some embodiments, the target eNB 206 may retrieve context information for the UE 202 from the source eNB 204 prior to transmitting the autonomous HO response 234. In response to receiving the autonomous HO response 234, the UE 202 may complete the connection with the target eNB 206, and may encode and transmit an autonomous HO completion 236 to the target eNB 206. The UE 202 may further release the connection between the UE 202 and the source eNB 204 after completing the connection with the target eNB 206. In some embodiments, the autonomous HO request 232, the autonomous HO response 234, the autonomous HO completion 236, or some combination thereof may be communicated via higher layers, such as radio resource control (RRC).

In some embodiments, the UE 202 may perform the autonomous HO operation independent of the timer expiration 226 and/or the measurement report 210. For example, the UE 202 may perform the autonomous HO operation in response to the UE 202 determining that an HO operation should be performed. In some embodiments, the UE 202 may determine that a quality of service provided by the source eNB 204 has dropped below a threshold quality of service and initiate the autonomous HO operation in response to the determined drop in quality of service. In particular, the UE 202 may select a target eNB from the candidate eNBs and initiate the autonomous HO request 232 in response to the determined drop in quality of service. In some of these embodiments, the autonomous HO operation may be limited to being performed when the autonomous HO timer 214 is not counting.

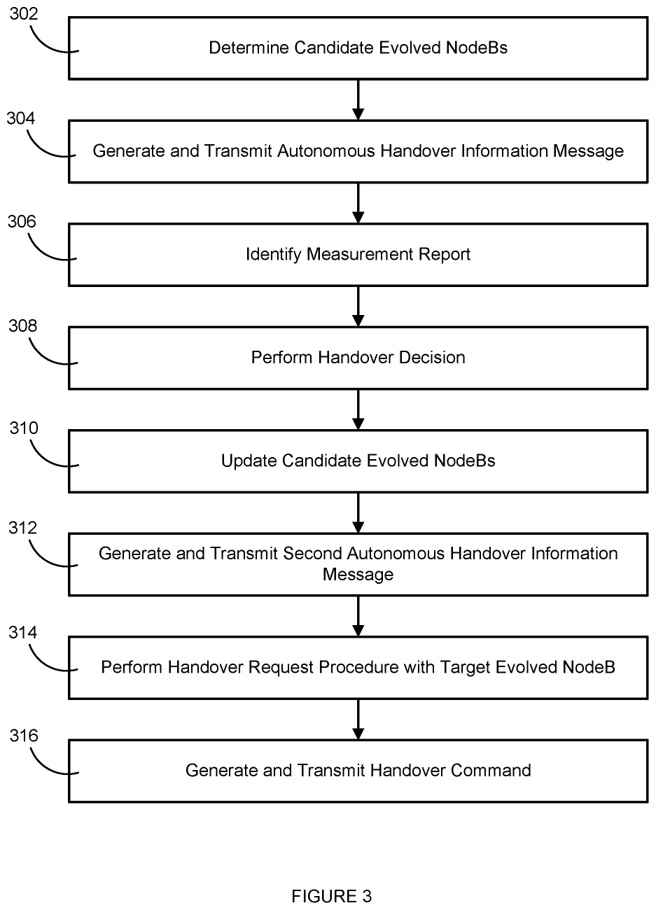

FIG. 3 illustrates a flow representation of a portion of an HO procedure, according to various embodiments. The HO procedure may include one or more of the features of the HO procedure of FIG. 2. In particular, the flow representation illustrates the portion of the HO procedure that may be performed by a source eNB, such as the source eNB 204.

In stage 302, the source eNB may determine candidate eNBs for a UE connected to the source eNB. The source eNB may determine the candidate eNBs as described in relation to FIG. 2. For example, the source eNB may determine the candidate eNBs based on cell information provided by the candidate eNBs, a plurality of other eNBs that include the candidate eNBs, information received from the UE, or some combination thereof. In some embodiments, the candidate eNBs may be limited to a predetermined number of eNBs.

In stage 304, the source eNB may generate and transmit an autonomous HO information message to the UE. The autonomous HO information message may include one or more of the features of the autonomous HO information message 208 (FIG. 2). The autonomous HO information message may include an indication of the candidate eNBs.

In stage 306, the source eNB may identify a measurement report received from the UE. The measurement report may include one or more of the features of the measurement report 210 (FIG. 2).

In stage 308, the source eNB may perform an HO decision. The HO decision may include one or more of the features of the HO decision 212 (FIG. 2).

In stage 310, the source eNB may update the candidate eNBs for the UE. Updating of the candidate eNBs may include one or more of the features of updating the candidate eNBs described in relation to FIG. 2. For example, the source eNB may analyze connectivity information indicated in the measurement report received from the UE. The source eNB may update the candidate eNBs based on the connectivity information.

In stage 312, the source eNB may generate and transmit a second autonomous HO information message to the UE. The second autonomous HO information message may include one or more of the features of the second autonomous HO information message 216 (FIG. 2). For example, the second autonomous HO information message may include an indication of the updated candidate eNBs. Further, in some embodiments and/or instances, the second autonomous HO information message may include an indication that the UE is to restart an autonomous HO timer and/or a value from which to restart the autonomous HO timer.

In stage 314, the source eNB may perform an HO request procedure with a target eNB. The HO request procedure may include transmitting an HO request to the target eNB and receiving an HO request ACK from the target eNB. The HO request may include one or more of the features of the HO request 218 (FIG. 2). The HO request ACK may include one or more of the features of the HO request ACK 220 (FIG. 2).

In stage 316, the source eNB may generate and transmit an HO command to the UE. The HO command may include one or more of the features of the HO command described in relation to FIG. 2.

In some embodiments and/or instances, stage 312 may be omitted. For example, the source eNB may omit transmission of the second autonomous HO information message if the updated candidate eNBs are the same candidate eNBs indicated in the autonomous HO information message of stage 304. Further, stage 312 may be omitted if the source eNB fails to identify the measurement report in stage 306.

In some embodiments and/or instances, stage 314 and stage 316 may be omitted. For example, the source eNB may omit performing the HO request, and generating and transmitting the HO command, if the source eNB determines that the UE is not to perform an HO operation during the HO decision of stage 308.

In some instances, stage 306 through stage 316 may be omitted. For example, the source eNB may fail to identify the measurement report, or a measurement report may not have been transmitted to the source eNB, in stage 306. Accordingly, stage 308 through stage 316, which may occur in response to the identification of the measurement report, may be omitted.

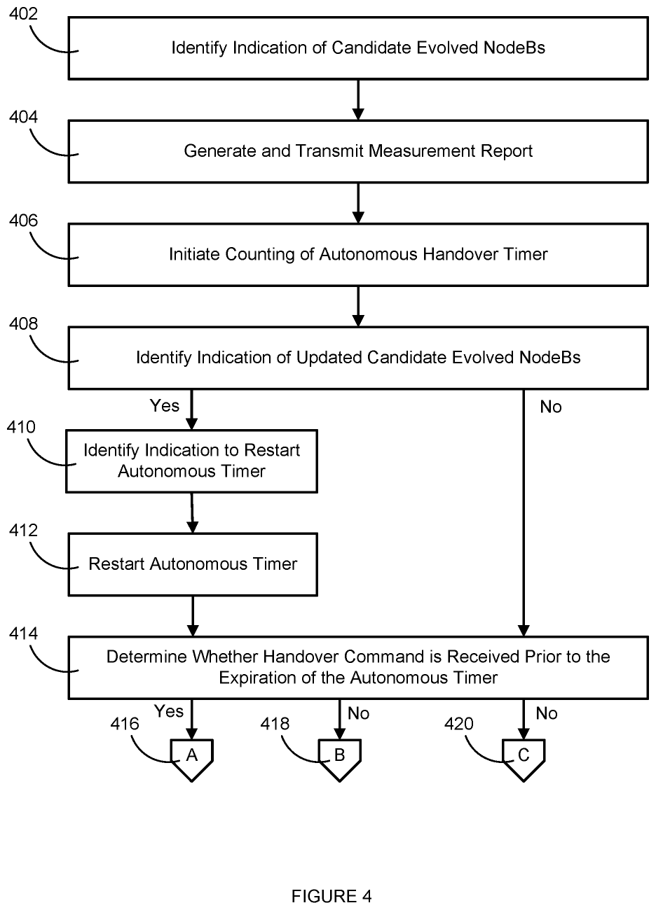

FIG. 4 illustrates a flow representation of another portion of the example HO procedure of FIG. 3, according to various embodiments. In particular, the flow representation illustrates the portion of the HO procedure that may be performed by a UE, such as the UE 202.

In stage 402, the UE may identify an indication of candidate eNBs for the UE. The indication of the candidate eNBs may be received in an autonomous HO information message (such as the autonomous HO information message 208 (FIG. 2)). The indication of the candidate eNBs may include one or more of the features of the indication of candidate eNBs described in relation to FIG. 2. The UE may store the indication of the candidate eNBs.

In stage 404, the UE may generate and transmit a measurement report. The measurement report may include one or more of the features of the measurement report 210 (FIG. 2). For example, the measurement report may include connectivity information for the UE with other eNBs located proximate to the UE. The eNBs located proximate to the UE may include any eNBs from which the UE detects reference signals, which may be utilized for generating the connectivity information.

In stage 406, the UE may initiate counting of an autonomous HO timer. Initiating the counting of the autonomous HO timer may include one or more of the features initiating the counting of the autonomous HO timer 214 (FIG. 2) described in relation to FIG. 2. The UE may initiate the counting of the autonomous HO timer in response to and/or upon transmission of the measurement report.

In stage 408, the UE may identify an indication of updated candidate eNBs for the UE. The indication of the updated candidate eNBs may be received from the source eNB in a second autonomous HO information message. The second autonomous HO information message may include one or more of the features of the second autonomous HO information message 216 (FIG. 2). In response to identifying the indication of the updated candidate eNBs, the UE may store the indication of the updated candidate eNBs. In some embodiments and/or instances, stage 408 may be omitted. For example, in embodiments and/or instances where the source eNB does not transmit a second autonomous HO information message, the UE may not identify the indication of the updated candidate eNBs.

In stage 410, the UE may identify an indication to restart the autonomous HO timer. The indication to restart the autonomous HO timer may be received in the second autonomous HO information message. In some embodiments, the UE may further identify an indication of a value at which to restart counting of the autonomous HO timer in the second autonomous HO information message.

In stage 412, the UE may restart the autonomous HO timer. The UE may restart counting of the autonomous HO timer in response to identification of the indication to restart the autonomous HO timer. In embodiments where the UE identifies the indication of the value, the UE may restart the counting of the autonomous HO timer from the value.

In some embodiments and/or instances, stage 410 and stage 412 may be omitted. For example, in embodiments where a second autonomous HO information message is omitted or the indication to restart the autonomous HO timer is omitted from the second autonomous HO information message, the UE may not identify the indication to restart the autonomous HO timer and may not restart the autonomous timer. In instances where the second autonomous HO information message indicates that the autonomous HO timer is not to be restarted or the indication is omitted from the second autonomous HO information message based on a determination that restarting the autonomous HO timer is not required, the UE may not identify the indication to restart the autonomous HO timer and may not restart the autonomous timer.

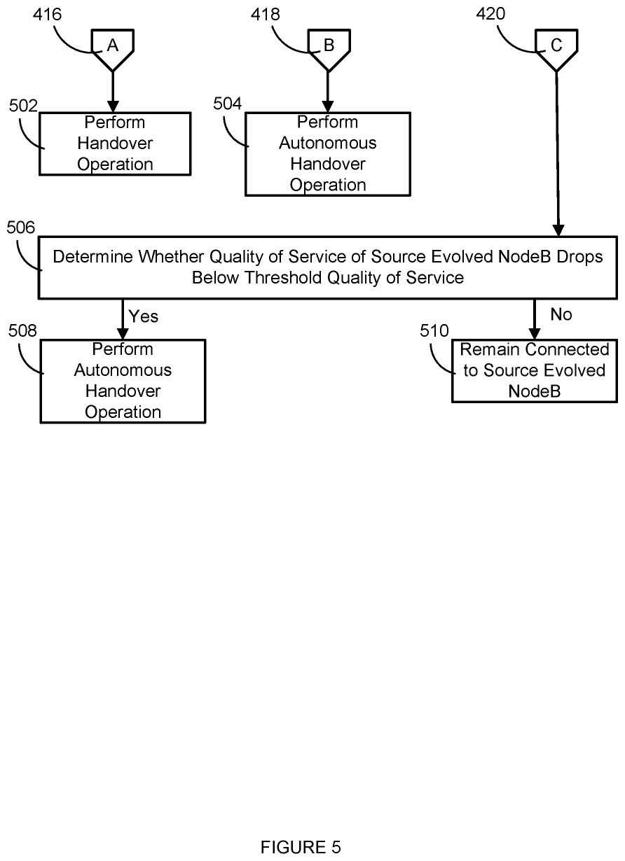

In stage 414, the UE may determine whether an HO command is received from the source eNB prior to the expiration of the autonomous HO timer. The HO command may include one or more of the features of the HO command described in relation to FIG. 2. For example, the UE may determine whether the HO command is received prior to a timer expiration (such as the timer expiration 226 (FIG. 2)), after the timer expiration, or not received. In response to the UE determining the HO command is received prior to the timer expiration, the procedure may proceed to connector 416. In response to the UE determining that the HO command is received after the timer expiration or not received, the procedure may proceed to connector 418 in some embodiments and to connector 420 in other embodiments. Connector 416, connector 418, and connector 420 indicate continuation of the procedure in FIG. 5.

FIG. 5 illustrates a continuation of the flow representation of FIG. 4, according to various embodiments. From connector 416, the procedure may proceed to stage 502. In stage 502, the UE may perform an HO operation to connect with a target eNB, such as the target eNB 206 (FIG. 2). Performing the HO operation may include one or more of the features of performing the HO operation described in relation to FIG. 5. For example, the UE may perform synchronization with contention free random access channel (RACH) or synchronization with contention-based RACH to establish a connection with the target eNB. Further, the UE may disconnect from the source eNB during the HO operation.

From connector 418, the procedure may proceed to stage 504. In stage 504, the UE may perform an autonomous HO operation. The autonomous HO operation may include one or more of the features of the autonomous HO operation described in relation to FIG. 2. For example, the UE may select a target eNB from the latest indication of candidate eNBs, which may include the indication of candidate eNBs received in the autonomous HO information message or the indication of updated eNBs received in the second autonomous HO information message. The UE may transmit an autonomous HO request, receive an autonomous HO response, transmit an autonomous HO completion, or some combination thereof to establish a connection with the target eNB. Further, the UE may release connection with the source eNB. The autonomous HO operation may be performed in response to the timer expiration of the autonomous HO timer.

From connector 420, the procedure may proceed to stage 506. In stage 506, the UE may determine whether a quality of service provided by the source eNB drops below a threshold quality of service. The threshold quality of service may be predefined or may be defined during configuration of the UE, which may occur in response to a configuration message received from an eNB (such as the source eNB or the target eNB). If the UE determines that the quality of service of the source eNB has dropped below the threshold quality of service, the procedure may proceed to stage 508. If the UE determines that the quality of service of the source eNB has not dropped below the threshold quality of service, the procedure may proceed to stage 510.

In stage 508, the UE may perform an autonomous HO operation. The autonomous HO operation may include one or more of the features of the autonomous HO operation described in relation to FIG. 2, and/or one or more of the features of the autonomous HO operation described in relation to stage 504. In particular, the UE may perform the autonomous HO operation to connect to the target eNB in response to the UE determining that the quality of service of the source eNB has dropped below the threshold quality of service.

In stage 510, the UE may remain connected to the source eNB. In particular, the UE may remain connected to the source eNB in response to the UE determining that the quality of service of the source eNB has not dropped below the threshold quality of service.

FIG. 6 illustrates an architecture of a system XQ00 of a network in accordance with some embodiments. The system XQ00 is shown to include a user equipment (UE) XQ01 and a UE XQ02. As used herein, the term “user equipment” or “UE” may refer to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface. In this example, UEs XQ01 and XQ02 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M), Internet of Things (IoT) devices, and/or the like.

In some embodiments, any of the UEs XQ01 and XQ02 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs XQ01 and XQ02 may be configured to connect, e.g., communicatively couple, with a radio access network (RAN) XQ10—the RAN XQ10 may be, for example, an Evolved Universal Mobile Telecommunications System (UMTS) Terrestrial Radio Access Network (E-UTRAN), a NextGen RAN (NG RAN), or some other type of RAN. The UEs XQ01 and XQ02 utilize connections (or channels) XQ03 and XQ04, respectively, each of which comprises a physical communications interface or layer (discussed in further detail infra). As used herein, the term “channel” may refer to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” may refer to a connection between two devices through a Radio Access Technology (RAT) for the purpose of transmitting and receiving information. In this example, the connections XQ03 and XQ04 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs XQ01 and XQ02 may further directly exchange communication data via a ProSe interface XQ05. The ProSe interface XQ05 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH). In various implementations, the SL interface XQ05 may be used in vehicular applications and communications technologies, which are often referred to as V2X systems. V2X is a mode of communication where UEs (for example, UEs XQ01, XQ02) communicate with each other directly over the PC5/SL interface XQ05 and can take place when the UEs XQ01, XQ02 are served by RAN nodes XQ11, XQ12 or when one or more UEs are outside a coverage area of the RAN XQ10. V2X may be classified into four different types: vehicle-to-vehicle (V2V), vehicle-to-infrastructure (V2I), vehicle-to-network (V2N), and vehicle-to-pedestrian (V2P). These V2X applications can use “co-operative awareness” to provide more intelligent services for end-users. For example, vUEs XQ01, XQ02, RAN nodes XQ11, XQ12, application servers XQ30, and pedestrian UEs XQ01, XQ02 may collect knowledge of their local environment (for example, information received from other vehicles or sensor equipment in proximity) to process and share that knowledge in order to provide more intelligent services, such as cooperative collision warning, autonomous driving, and the like. In these implementations, the UEs XQ01, XQ02 may be implemented/employed as Vehicle Embedded Communications Systems (VECS) or vUEs.

The UE XQ02 is shown to be configured to access an access point (AP) XQ06 (also referred to as “WLAN node XQ06”, “WLAN XQ06”, “WLAN Termination XQ06” or “WT XQ06” or the like) via connection XQ07. The connection XQ07 can comprise a local wireless connection, such as a connection consistent with any IEEE 802.11 protocol, wherein the AP XQ06 would comprise a wireless fidelity (WiFi®) router. In this example, the AP XQ06 is shown to be connected to the Internet without connecting to the core network of the wireless system (described in further detail below). In various embodiments, the UE XQ02, RAN XQ10, and AP XQ06 may be configured to utilize LTE-WLAN aggregation (LWA) operation and/or WLAN LTE/WLAN Radio Level Integration with IPsec Tunnel (LWIP) operation. The LWA operation may involve the UE XQ02 in RRC_CONNECTED being configured by a RAN node XQ11, XQ12 to utilize radio resources of LTE and WLAN. LWIP operation may involve the UE XQ02 using WLAN radio resources (e.g., connection XQ07) via Internet Protocol Security (IPsec) protocol tunneling to authenticate and encrypt packets (e.g., internet protocol (IP) packets) sent over the connection XQ07. IPsec tunneling may include encapsulating entirety of original IP packets and adding a new packet header, thereby protecting the original header of the IP packets.

The RAN XQ10 can include one or more access nodes that enable the connections XQ03 and XQ04. As used herein, the terms “access node,” “access point,” or the like may describe equipment that provides the radio baseband functions for data and/or voice connectivity between a network and one or more users. These access nodes can be referred to as base stations (BS), NodeBs, evolved NodeBs (eNBs), next Generation NodeBs (gNB), RAN nodes, Road Side Units (RSUs), and so forth, and can comprise ground stations (e.g., terrestrial access points) or satellite stations providing coverage within a geographic area (e.g., a cell). The term “Road Side Unit” or “RSU” may refer to any transportation infrastructure entity implemented in or by a gNB/eNB/RAN node or a stationary (or relatively stationary) UE, where an RSU implemented in or by a UE may be referred to as a “UE-type RSU”, an RSU implemented in or by an eNB may be referred to as an “eNB-type RSU.” The RAN XQ10 may include one or more RAN nodes for providing macrocells, e.g., macro RAN node XQ11, and one or more RAN nodes for providing femtocells or picocells (e.g., cells having smaller coverage areas, smaller user capacity, or higher bandwidth compared to macrocells), e.g., low power (LP) RAN node XQ12.

Any of the RAN nodes XQ11 and XQ12 can terminate the air interface protocol and can be the first point of contact for the UEs XQ01 and XQ02. In some embodiments, any of the RAN nodes XQ11 and XQ12 can fulfill various logical functions for the RAN XQ10 including, but not limited to, radio network controller (RNC) functions such as radio bearer management, uplink and downlink dynamic radio resource management and data packet scheduling, and mobility management.

In accordance with some embodiments, the UEs XQ01 and XQ02 can be configured to communicate using Orthogonal Frequency-Division Multiplexing (OFDM) communication signals with each other or with any of the RAN nodes XQ11 and XQ12 over a multicarrier communication channel in accordance with various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes XQ11 and XQ12 to the UEs XQ01 and XQ02, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs XQ01 and XQ02. The physical downlink control channel (PDCCH) may carry information about the transport format and resource allocations related to the PDSCH channel, among other things. It may also inform the UEs XQ01 and XQ02 about the transport format, resource allocation, and H-ARQ (Hybrid Automatic Repeat Request) information related to the uplink shared channel. Typically, downlink scheduling (assigning control and shared channel resource blocks to the UE XQ02 within a cell) may be performed at any of the RAN nodes XQ11 and XQ12 based on channel quality information fed back from any of the UEs XQ01 and XQ02. The downlink resource assignment information may be sent on the PDCCH used for (e.g., assigned to) each of the UEs XQ01 and XQ02.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced control channel elements (ECCEs). Similar to above, each ECCE may correspond to nine sets of four physical resource elements known as an enhanced resource element groups (EREGs). An ECCE may have other numbers of EREGs in some situations.

The RAN XQ10 is shown to be communicatively coupled to a core network (CN) XQ20—via an S1 interface XQ13. In embodiments, the CN XQ20 may be an evolved packet core (EPC) network, a NextGen Packet Core (NPC) network, or some other type of CN. In this embodiment the S1 interface XQ13 is split into two parts: the S1-U interface XQ14, which carries traffic data between the RAN nodes XQ11 and XQ12 and the serving gateway (S-GW) XQ22, and the S1-mobility management entity (MME) interface XQ15, which is a signaling interface between the RAN nodes XQ11 and XQ12 and MMEs XQ21.

In this embodiment, the CN XQ20 comprises the MMEs XQ21, the S-GW XQ22, the Packet Data Network (PDN) Gateway (P-GW) XQ23, and a home subscriber server (HSS) XQ24. The MMEs XQ21 may be similar in function to the control plane of legacy Serving General Packet Radio Service (GPRS) Support Nodes (SGSN). The MMEs XQ21 may manage mobility aspects in access such as gateway selection and tracking area list management. The HSS XQ24 may comprise a database for network users, including subscription-related information to support the network entities' handling of communication sessions. The CN XQ20 may comprise one or several HSSs XQ24, depending on the number of mobile subscribers, on the capacity of the equipment, on the organization of the network, etc. For example, the HSS XQ24 can provide support for routing/roaming, authentication, authorization, naming/addressing resolution, location dependencies, etc.

The S-GW XQ22 may terminate the S1 interface XQ13 towards the RAN XQ10, and routes data packets between the RAN XQ10 and the CN XQ20. In addition, the S-GW XQ22 may be a local mobility anchor point for inter-RAN node handovers and also may provide an anchor for inter-3GPP mobility. Other responsibilities may include lawful intercept, charging, and some policy enforcement.

The P-GW XQ23 may terminate an SGi interface toward a PDN. The P-GW XQ23 may route data packets between the EPC network XQ23 and external networks such as a network including the application server XQ30 (alternatively referred to as application function (AF)) via an Internet Protocol (IP) interface XQ25. Generally, the application server XQ30 may be an element offering applications that use IP bearer resources with the core network (e.g., UMTS Packet Services (PS) domain, LTE PS data services, etc.). In this embodiment, the P-GW XQ23 is shown to be communicatively coupled to an application server XQ30 via an IP communications interface XQ25. The application server XQ30 can also be configured to support one or more communication services (e.g., Voice-over-Internet Protocol (VoIP) sessions, PTT sessions, group communication sessions, social networking services, etc.) for the UEs XQ01 and XQ02 via the CN XQ20.

The P-GW XQ23 may further be a node for policy enforcement and charging data collection. Policy and Charging Enforcement Function (PCRF) XQ26 is the policy and charging control element of the CN XQ20. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF XQ26 may be communicatively coupled to the application server XQ30 via the P-GW XQ23. The application server XQ30 may signal the PCRF XQ26 to indicate a new service flow and select the appropriate Quality of Service (QoS) and charging parameters. The PCRF XQ26 may provision this rule into a Policy and Charging Enforcement Function (PCEF) (not shown) with the appropriate traffic flow template (TFT) and QoS class of identifier (QCI), which commences the QoS and charging as specified by the application server XQ30.

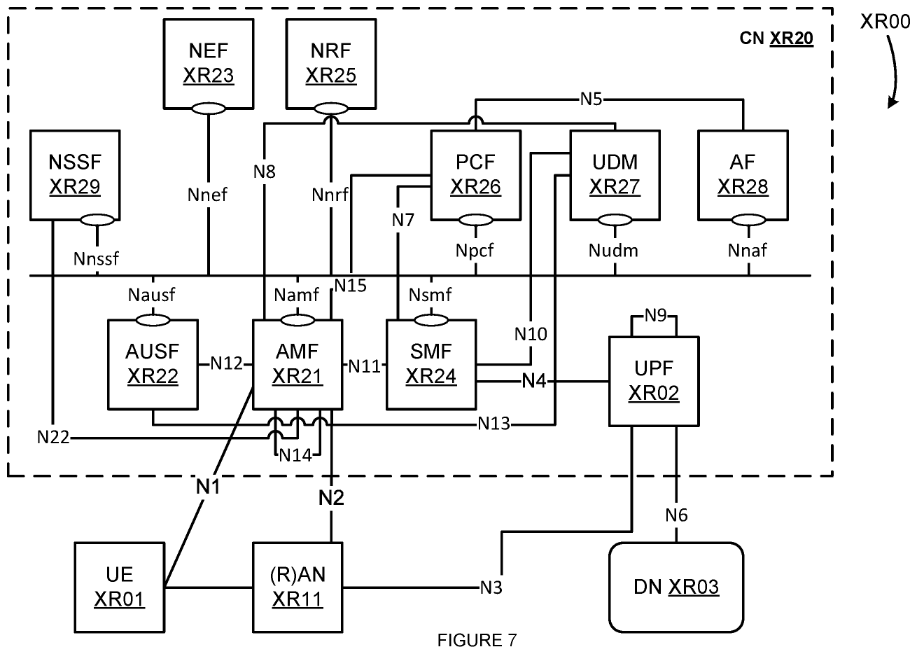

FIG. 7 illustrates an architecture of a system XR00 of a network in accordance with some embodiments. The system XR00 is shown to include a UE XR01, which may be the same or similar to UEs XQ01 and XQ02 discussed previously; a RAN node XR11, which may be the same or similar to RAN nodes XQ11 and XQ12 discussed previously; a data network (DN) XR03, which may be, for example, operator services, Internet access or 3rd party services; and a 5G Core Network (5GC or CN) XR20.

The CN XR20 may include an Authentication Server Function (AUSF) XR22; an Access and Mobility Management Function (AMF) XR21; a Session Management Function (SMF) XR24; a Network Exposure Function (NEF) XR23; a Policy Control Function (PCF) XR26; a Network Function (NF) Repository Function (NRF) XR25; a Unified Data Management (UDM) XR27; an Application Function (AF) XR28; a User Plane Function (UPF) XR02; and a Network Slice Selection Function (NSSF) XR29.

The UPF XR02 may act as an anchor point for intra-RAT and inter-RAT mobility, an external PDU session point of interconnect to DN XR03, and a branching point to support multi-homed PDU session. The UPF XR02 may also perform packet routing and forwarding, perform packet inspection, enforce user plane part of policy rules, lawfully intercept packets (UP collection), traffic usage reporting, perform QoS handling for user plane (e.g., packet filtering, gating, UL/DL rate enforcement), perform Uplink Traffic verification (e.g., SDF to QoS flow mapping), transport level packet marking in the uplink and downlink, and downlink packet buffering and downlink data notification triggering. UPF XR02 may include an uplink classifier to support routing traffic flows to a data network. The DN XR03 may represent various network operator services, Internet access, or third party services. DN XR03 may include, or be similar to, application server XQ30 discussed previously. The UPF XR02 may interact with the SMF XR24 via an N4 reference point between the SMF XR24 and the UPF XR02.

The AUSF XR22 may store data for authentication of UE XR01 and handle authentication related functionality. The AUSF XR22 may facilitate a common authentication framework for various access types. The AUSF XR22 may communicate with the AMF XR21 via an N12 reference point between the AMF XR21 and the AUSF XR22; and may communicate with the UDM XR27 via an N13 reference point between the UDM XR27 and the AUSF XR22. Additionally, the AUSF XR22 may exhibit an Nausf service-based interface.

The AMF XR21 may be responsible for registration management (e.g., for registering UE XR01, etc.), connection management, reachability management, mobility management, and lawful interception of AMF-related events, and access authentication and authorization. The AMF XR21 may be a termination point for an N11 reference point between the AMF XR21 and the SMF XR24. The AMF XR21 may provide transport for Session Management (SM) messages between the UE XR01 and the SMF XR24, and act as a transparent proxy for routing SM messages. AMF XR21 may also provide transport for short message service (SMS) messages between UE XR01 and an SMS function (SMSF) (not shown by FIG. 7). AMF XR21 may act as Security Anchor Function (SEA), which may include interaction with the AUSF XR22 and the UE XR01, and receipt of an intermediate key that was established as a result of the UE XR01 authentication process. Where USIM based authentication is used, the AMF XR21 may retrieve the security material from the AUSF XR22. AMF XR21 may also include a Security Context Management (SCM) function, which receives a key from the SEA that it uses to derive access-network specific keys. Furthermore, AMF XR21 may be a termination point of RAN CP interface, which may include or be an N2 reference point between the (R)AN XR11 and the AMF XR21; and the AMF XR21 may be a termination point of NAS (N1) signalling, and perform NAS ciphering and integrity protection.

AMF XR21 may also support NAS signalling with a UE XR01 over an N3 interworking-function (IWF) interface. The N3IWF may be used to provide access to untrusted entities. N3IWF may be a termination point for the N2 interface between the (R)AN XR11 and the AMF XR21 for the control plane, and may be a termination point for the N3 reference point between the (R)AN XR11 and the UPF XR02 for the user plane. As such, the AMF XR21 may handle N2 signalling from the SMF XR24 and the AMF XR21 for PDU sessions and QoS, encapsulate/de-encapsulate packets for IPSec and N3 tunneling, mark N3 user-plane packets in the uplink, and enforce QoS corresponding to N3 packet marking, taking into account QoS requirements associated to such marking received over N2. N3IWF may also relay uplink and downlink control-plane NAS signalling between the UE XR01 and AMF XR21 via an N1 reference point between the UE XR01 and the AMF XR21, and relay uplink and downlink user-plane packets between the UE XR01 and UPF XR02. The N3IWF also provides mechanisms for IPsec tunnel establishment with the UE XR01. The AMF XR21 may exhibit an Namf service-based interface, and may be a termination point for an N14 reference point between two AMFs XR21 and an N17 reference point between the AMF XR21 and a 5G-Equipment Identity Register (5G-EIR) (not shown by FIG. 7).

The SMF XR24 may be responsible for session management (e.g., session establishment, modify and release, including tunnel maintain between UPF and AN node); UE IP address allocation & management (including optional Authorization); Selection and control of UP function; Configures traffic steering at UPF to route traffic to proper destination; termination of interfaces towards Policy control functions; control part of policy enforcement and QoS; lawful intercept (for SM events and interface to LI System); termination of SM parts of NAS messages; downlink Data Notification; initiation of AN specific SM information, sent via AMF over N2 to AN; and determination of SSC mode of a session. The SMF XR24 may include the following roaming functionality: handle local enforcement to apply QoS SLAB (VPLMN); charging data collection and charging interface (VPLMN); lawful intercept (in VPLMN for SM events and interface to LI System); and support for interaction with external DN for transport of signalling for PDU session authorization/authentication by external DN. An N16 reference point between two SMFs XR24 may be included in the system XR00, which may be between another SMF XR24 in a visited network and the SMF XR24 in the home network in roaming scenarios. Additionally, the SMF XR24 may exhibit the Nsmf service-based interface.

The NEF XR23 may provide means for securely exposing the services and capabilities provided by 3GPP network functions for third party, internal exposure/re-exposure, Application Functions (e.g., AF XR28), edge computing or fog computing systems, etc. In such embodiments, the NEF XR23 may authenticate, authorize, and/or throttle the AFs. NEF XR23 may also translate information exchanged with the AF XR28 and information exchanged with internal network functions. For example, the NEF XR23 may translate between an AF-Service-Identifier and an internal 5GC information. NEF XR23 may also receive information from other network functions (NFs) based on exposed capabilities of other network functions. This information may be stored at the NEF XR23 as structured data, or at a data storage NF using standardized interfaces. The stored information can then be re-exposed by the NEF XR23 to other NFs and AFs, and/or used for other purposes such as analytics. Additionally, the NEF XR23 may exhibit an Nnef service-based interface.

The NRF XR25 may support service discovery functions, receive NF Discovery Requests from NF instances, and provide the information of the discovered NF instances to the NF instances. NRF XR25 also maintains information of available NF instances and their supported services. As used herein, the terms “instantiate”, “instantiation”, and the like may refer to the creation of an instance, and an “instance” may refer to a concrete occurrence of an object, which may occur, for example, during execution of program code. Additionally, the NRF XR25 may exhibit the Nnrf service-based interface.

The PCF XR26 may provide policy rules to control plane function(s) to enforce them, and may also support unified policy framework to govern network behaviour. The PCF XR26 may also implement a front end (FE) to access subscription information relevant for policy decisions in a UDR of the UDM XR27. The PCF XR26 may communicate with the AMF XR21 via an N15 reference point between the PCF XR26 and the AMF XR21, which may include a PCF XR26 in a visited network and the AMF XR21 in case of roaming scenarios. The PCF XR26 may communicate with the AF XR28 via an N5 reference point between the PCF XR26 and the AF XR28; and with the SMF XR24 via an N7 reference point between the PCF XR26 and the SMF XR24. The system XR00 and/or CN XR20 may also include an N24 reference point between the PCF XR26 (in the home network) and a PCF XR26 in a visited network. Additionally, the PCF XR26 may exhibit an Npcf service-based interface.

The UDM XR27 may handle subscription-related information to support the network entities' handling of communication sessions, and may store subscription data of UE XR01. For example, subscription data may be communicated between the UDM XR27 and the AMF XR21 via an N8 reference point between the UDM XR27 and the AMF XR21 (not shown by FIG. 7). The UDM XR27 may include two parts, an application FE and a User Data Repository (UDR) (the FE and UDR are not shown by FIG. 7). The UDR may store subscription data and policy data for the UDM XR27 and the PCF XR26, and/or structured data for exposure and application data (including Packet Flow Descriptions (PFDs) for application detection, application request information for multiple UEs XR01) for the NEF XR23. The Nudr service-based interface may be exhibited by the UDR to allow the UDM XR27, PCF XR26, and NEF XR23 to access a particular set of the stored data, as well as to read, update (e.g., add, modify), delete, and subscribe to notification of relevant data changes in the UDR. The UDM XR27 may include a UDM FE, which is in charge of processing of credentials, location management, subscription management and so on. Several different front ends may serve the same user in different transactions. The UDM-FE accesses subscription information stored in the UDR and performs authentication credential processing; user identification handling; access authorization; registration/mobility management; and subscription management. The UDR may interact with the SMF XR24 via an N10 reference point between the UDM XR27 and the SMF XR24. UDM XR27 may also support SMS management, wherein an SMS-FE implements the similar application logic as discussed previously. Additionally, the UDM XR27 may exhibit the Nudm service-based interface.

The AF XR28 may provide application influence on traffic routing, provide access to the Network Capability Exposure (NCE), and interact with the policy framework for policy control. The NCE may be a mechanism that allows the 5GC and AF XR28 to provide information to each other via NEF XR23, which may be used for edge computing implementations. In such implementations, the network operator and third party services may be hosted close to the UE XR01 access point of attachment to achieve an efficient service delivery through the reduced end-to-end latency and load on the transport network. For edge computing implementations, the 5GC may select a UPF XR02 close to the UE XR01 and execute traffic steering from the UPF XR02 to DN XR03 via the N6 interface. This may be based on the UE subscription data, UE location, and information provided by the AF XR28. In this way, the AF XR28 may influence UPF (re)selection and traffic routing. Based on operator deployment, when AF XR28 is considered to be a trusted entity, the network operator may permit AF XR28 to interact directly with relevant NFs. Additionally, the AF XR28 may exhibit an Naf service-based interface.

The NSSF XR29 may select a set of network slice instances serving the UE XR01. The NSSF XR29 may also determine allowed Network Slice Selection Assistance Information (NSSAI) and the mapping to the Subscribed Single-NSSAIs (S-NSSAIs), if needed. The NSSF XR29 may also determine the AMF set to be used to serve the UE XR01, or a list of candidate AMF(s) XR21 based on a suitable configuration and possibly by querying the NRF XR25. The selection of a set of network slice instances for the UE XR01 may be triggered by the AMF XR21 with which the UE XR01 is registered by interacting with the NSSF XR29, which may lead to a change of AMF XR21. The NSSF XR29 may interact with the AMF XR21 via an N22 reference point between AMF XR21 and NSSF XR29; and may communicate with another NSSF XR29 in a visited network via an N31 reference point (not shown by FIG. 7). Additionally, the NSSF XR29 may exhibit an Nnssf service-based interface.

As discussed previously, the CN XR20 may include an SMSF, which may be responsible for SMS subscription checking and verification, and relaying SM messages to/from the UE XR01 to/from other entities, such as an SMS-GMSC/IWMSC/SMS-router. The SMS may also interact with AMF XR21 and UDM XR27 for notification procedure that the UE XR01 is available for SMS transfer (e.g., set a UE not reachable flag, and notifying UDM XR27 when UE XR01 is available for SMS).

The CN XR20 may also include other elements that are not shown by FIG. 7, such as a Data Storage system/architecture, a 5G-Equipment Identity Register (5G-EIR), a Security Edge Protection Proxy (SEPP), and the like. The Data Storage system may include a Structured Data Storage network function (SDSF), an Unstructured Data Storage network function (UDSF), and/or the like. Any NF may store and retrieve unstructured data into/from the UDSF (e.g., UE contexts), via N18 reference point between any NF and the UDSF (not shown by FIG. 7). Individual NFs may share a UDSF for storing their respective unstructured data or individual NFs may each have their own UDSF located at or near the individual NFs. Additionally, the UDSF may exhibit an Nudsf service-based interface (not shown by FIG. 7). The 5G-EIR may be an NF that checks the status of Permanent Equipment Identifiers (PEI) for determining whether particular equipment/entities are blacklisted from the network; and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 7 for clarity. In one example, the CN XR20 may include an Nx interface, which is an inter-CN interface between the MME (e.g., MME XQ21) and the AMF XR21 in order to enable interworking between CN XR20 and CN XQ20. Other example interfaces/reference points may include an N5G-EIR service-based interface exhibited by a 5G-EIR, an N27 reference point between the NRF in the visited network and the NRF in the home network; and an N31 reference point between the NSSF in the visited network and the NSSF in the home network.

In yet another example, system XR00 may include multiple RAN nodes XR11 wherein an Xn interface is defined between two or more RAN nodes XR11 (e.g., gNBs and the like) connecting to 5GC XR20, between a RAN node XR11 (e.g., gNB) connecting to 5GC XR20 and an eNB (e.g., a RAN node XQ11 of FIG. 6), and/or between two eNBs connecting to 5GC XR20. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE XR01 in a connected mode (e.g., CM-CONNECTED) including functionality to manage the UE mobility for connected mode between one or more RAN nodes XR11. The mobility support may include context transfer from an old (source) serving RAN node XR11 to new (target) serving RAN node XR11; and control of user plane tunnels between old (source) serving RAN node XR11 to new (target) serving RAN node XR11. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on an SCTP layer. The SCTP layer may be on top of an IP layer. The SCTP layer provides the guaranteed delivery of application layer messages. In the transport IP layer, point-to-point transmission is used to deliver the signaling PDUs. In other implementations, the Xn-U protocol stack and/or the Xn-C protocol stack may be the same or similar to the user plane and/or control plane protocol stack(s) shown and described herein.

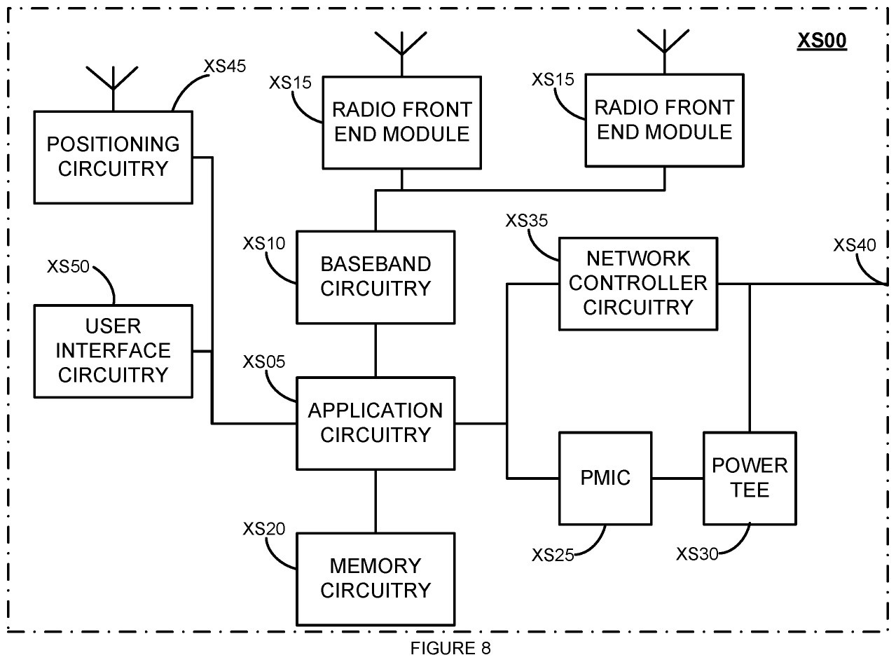

FIG. 8 illustrates an example of infrastructure equipment XS00 in accordance with various embodiments. The infrastructure equipment XS00 (or “system XS00”) may be implemented as a base station, radio head, RAN node, etc., such as the RAN nodes XQ11 and XQ12, and/or AP XQ06 shown and described previously. In other examples, the system XS00 could be implemented in or by a UE, application server(s) XQ30, and/or any other element/device discussed herein. The system XS00 may include one or more of application circuitry XS05, baseband circuitry XS10, one or more radio front end modules XS15, memory XS20, power management integrated circuitry (PMIC) XS25, power tee circuitry XS30, network controller XS35, network interface connector XS40, satellite positioning circuitry XS45, and user interface XS50. In some embodiments, the device XT00 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

As used herein, the term “circuitry” may refer to, is part of, or includes hardware components such as an electronic circuit, a logic circuit, a processor (shared, dedicated, or group) and/or memory (shared, dedicated, or group), an application specific integrated circuit (ASIC), a field-programmable device (FPD) (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality. In addition, the term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The terms “application circuitry” and/or “baseband circuitry” may be considered synonymous to, and may be referred to as, “processor circuitry.” As used herein, the term “processor circuitry” may refer to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

Furthermore, the various components of the core network XQ20 (or CN XR20 discussed infra) may be referred to as “network elements.” The term “network element” may describe a physical or virtualized equipment used to provide wired or wireless communication network services. The term “network element” may be considered synonymous to and/or referred to as a networked computer, networking hardware, network equipment, network node, router, switch, hub, bridge, radio network controller, radio access network device, gateway, server, virtualized network function (VNF), network functions virtualization infrastructure (NFVI), and/or the like.

Application circuitry XS05 may include one or more central processing unit (CPU) cores and one or more of cache memory, low drop-out voltage regulators (LDOs), interrupt controllers, serial interfaces such as SPI, I²C or universal programmable serial interface module, real time clock (RTC), timer-counters including interval and watchdog timers, general purpose input/output (I/O or IO), memory card controllers such as Secure Digital (SD/)MultiMediaCard (MMC) or similar, Universal Serial Bus (USB) interfaces, Mobile Industry Processor Interface (MIPI) interfaces and Joint Test Access Group (JTAG) test access ports. As examples, the application circuitry XS05 may include one or more Intel Pentium®, Core®, or Xeon® processor(s); Advanced Micro Devices (AMD) Ryzen® processor(s), Accelerated Processing Units (APUs), or Epyc® processors; and/or the like. In some embodiments, the system XS00 may not utilize application circuitry XS05, and instead may include a special-purpose processor/controller to process IP data received from an EPC or 5GC, for example.

Additionally or alternatively, application circuitry XS05 may include circuitry such as, but not limited to, one or more field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry XS05 may comprise logic blocks or logic fabric including other interconnected resources that may be programmed to perform various functions, such as the procedures, methods, functions, etc. of the various embodiments discussed herein. In such embodiments, the circuitry of application circuitry XS05 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in lookup-tables (LUTs) and the like.

The baseband circuitry XS10 may be implemented, for example, as a solder-down substrate including one or more integrated circuits, a single packaged integrated circuit soldered to a main circuit board or a multi-chip module containing two or more integrated circuits. Although not shown, baseband circuitry XS10 may comprise one or more digital baseband systems, which may be coupled via an interconnect subsystem to a CPU subsystem, an audio subsystem, and an interface subsystem. The digital baseband subsystems may also be coupled to a digital baseband interface and a mixed-signal baseband sub-system via another interconnect subsystem. Each of the interconnect subsystems may include a bus system, point-to-point connections, network-on-chip (NOC) structures, and/or some other suitable bus or interconnect technology, such as those discussed herein. The audio sub-system may include digital signal processing circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry XS10 may include protocol processing circuitry with one or more instances of control circuitry (not shown) to provide control functions for the digital baseband circuitry and/or radio frequency circuitry (for example, the radio front end modules XS15).

User interface circuitry XS50 may include one or more user interfaces designed to enable user interaction with the system XS00 or peripheral component interfaces designed to enable peripheral component interaction with the system XS00. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a non-volatile memory port, a universal serial bus (USB) port, an audio jack, a power supply interface, etc.

The radio front end modules (RFEMs) XS15 may comprise a millimeter wave RFEM and one or more sub-millimeter wave radio frequency integrated circuits (RFICs). In some implementations, the one or more sub-millimeter wave RFICs may be physically separated from the millimeter wave RFEM. The RFICs may include connections to one or more antennas or antenna arrays, and the RFEM may be connected to multiple antennas. In alternative implementations, both millimeter wave and sub-millimeter wave radio functions may be implemented in the same physical radio front end module XS15. The RFEMs XS15 may incorporate both millimeter wave antennas and sub-millimeter wave antennas.

The memory circuitry XS20 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry XS20 may be implemented as one or more of solder down packaged integrated circuits, socketed memory modules and plug-in memory cards.

The PMIC XS25 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry XS30 may provide for electrical power drawn from a network cable to provide both power supply and data connectivity to the infrastructure equipment XS00 using a single cable.

The network controller circuitry XS35 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment XS00 via network interface connector XS40 using a physical connection, which may be electrical (commonly referred to as a “copper interconnect”), optical, or wireless. The network controller circuitry XS35 may include one or more dedicated processors and/or FPGAs to communicate using one or more of the aforementioned protocol. In some implementations, the network controller circuitry XS35 may include multiple controllers to provide connectivity to other networks using the same or different protocols.

The positioning circuitry XS45 may include circuitry to receive and decode signals transmitted by one or more navigation satellite constellations of a global navigation satellite system (GNSS). Examples of navigation satellite constellations (or GNSS) may include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry XS45 may comprise various hardware elements (e.g., including hardware devices such as switches, filters, amplifiers, antenna elements, and the like to facilitate the communications over-the-air (OTA) communications) to communicate with components of a positioning network, such as navigation satellite constellation nodes.

Nodes or satellites of the navigation satellite constellation(s) (“GNSS nodes”) may provide positioning services by continuously transmitting or broadcasting GNSS signals along a line of sight, which may be used by GNSS receivers (e.g., positioning circuitry XS45 and/or positioning circuitry implemented by UEs XQ01, XQ02, or the like) to determine their GNSS position. The GNSS signals may include a pseudorandom code (e.g., a sequence of ones and zeros) that is known to the GNSS receiver and a message that includes a time of transmission (ToT) of a code epoch (e.g., a defined point in the pseudorandom code sequence) and the GNSS node position at the ToT. The GNSS receivers may monitor/measure the GNSS signals transmitted/broadcasted by a plurality of GNSS nodes (e.g., four or more satellites) and solve various equations to determine a corresponding GNSS position (e.g., a spatial coordinate). The GNSS receivers also implement clocks that are typically less stable and less precise than the atomic clocks of the GNSS nodes, and the GNSS receivers may use the measured GNSS signals to determine the GNSS receivers' deviation from true time (e.g., an offset of the GNSS receiver clock relative to the GNSS node time). In some embodiments, the positioning circuitry XS45 may include a Micro-Technology for Positioning, Navigation, and Timing (Micro-PNT) IC that uses a master timing clock to perform position tracking/estimation without GNSS assistance.

The GNSS receivers may measure the time of arrivals (ToAs) of the GNSS signals from the plurality of GNSS nodes according to its own clock. The GNSS receivers may determine ToF values for each received GNSS signal from the ToAs and the ToTs, and then may determine, from the ToFs, a three-dimensional (3D) position and clock deviation. The 3D position may then be converted into a latitude, longitude and altitude. The positioning circuitry XS45 may provide data to application circuitry XS05, which may include one or more of position data or time data. Application circuitry XS05 may use the time data to synchronize operations with other radio base stations (e.g., RAN nodes XQ11, XQ12, XR11 or the like).

The components shown by FIG. 8 may communicate with one another using interface circuitry. As used herein, the term “interface circuitry” may refer to, is part of, or includes circuitry providing for the exchange of information between two or more components or devices. The term “interface circuitry” may refer to one or more hardware interfaces, for example, buses, input/output (I/O) interfaces, peripheral component interfaces, network interface cards, and/or the like. Any suitable bus technology may be used in various implementations, which may include any number of technologies, including industry standard architecture (ISA), extended ISA (EISA), peripheral component interconnect (PCI), peripheral component interconnect extended (PCIx), PCI express (PCIe), or any number of other technologies. The bus may be a proprietary bus, for example, used in a SoC based system. Other bus systems may be included, such as an I²C interface, an SPI interface, point to point interfaces, and a power bus, among others.

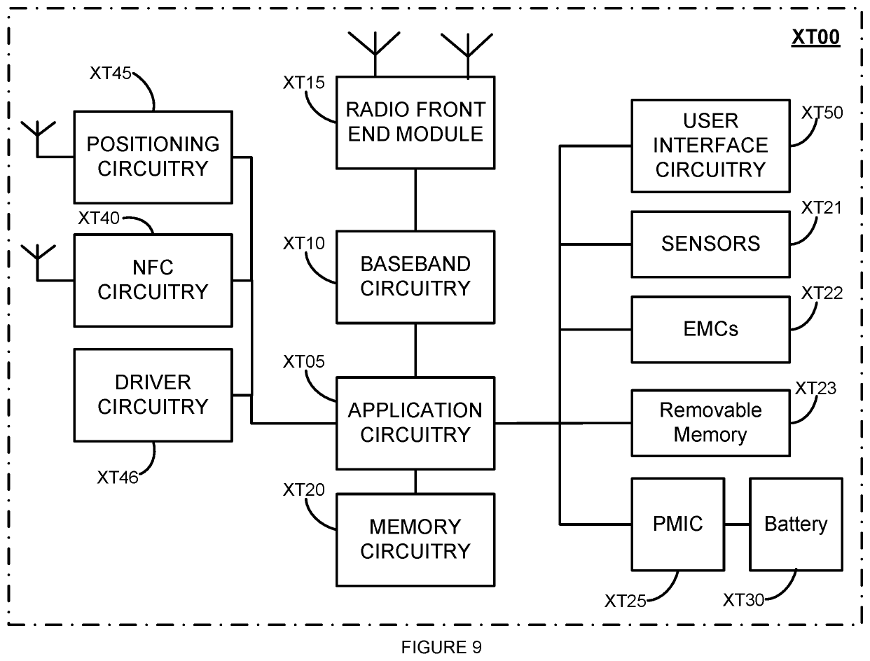

FIG. 9 illustrates an example of a platform XT00 (or “device XT00”) in accordance with various embodiments. In embodiments, the computer platform XT00 may be suitable for use as UEs XQ01, XQ02, XR01, application servers XQ30, and/or any other element/device discussed herein. The platform XT00 may include any combinations of the components shown in the example. The components of platform XT00 may be implemented as integrated circuits (ICs), portions thereof, discrete electronic devices, or other modules, logic, hardware, software, firmware, or a combination thereof adapted in the computer platform XT00, or as components otherwise incorporated within a chassis of a larger system. The block diagram of FIG. 9 is intended to show a high level view of components of the computer platform XT00. However, some of the components shown may be omitted, additional components may be present, and different arrangement of the components shown may occur in other implementations.

The application circuitry XT05 may include circuitry such as, but not limited to, single-core or multi-core processors and one or more of cache memory, low drop-out voltage regulators (LDOs), interrupt controllers, serial interfaces such as serial peripheral interface (SPI), inter-integrated circuit (I²C) or universal programmable serial interface circuit, real time clock (RTC), timer-counters including interval and watchdog timers, general purpose input-output (IO), memory card controllers such as secure digital/multimedia card (SD/MMC) or similar, universal serial bus (USB) interfaces, mobile industry processor interface (MIPI) interfaces and Joint Test Access Group (JTAG) test access ports. The processor(s) may include any combination of general-purpose processors and/or dedicated processors (e.g., graphics processors, application processors, etc.). The processors (or cores) may be coupled with or may include memory/storage and may be configured to execute instructions stored in the memory/storage to enable various applications or operating systems to run on the platform XT00. In some embodiments, processors of application circuitry XS05/XT05 may process IP data packets received from an EPC or 5GC.

Application circuitry XT05 may be or include a microprocessor, a multi-core processor, a multithreaded processor, an ultra-low voltage processor, an embedded processor, or other known processing element. In one example, the application circuitry XT05 may include an Intel® Architecture Core™ based processor, such as a Quark™, an Atom™, an i3, an i5, an i7, or an MCU-class processor, or another such processor available from Intel® Corporation, Santa Clara, Calif. The processors of the application circuitry XT05 may also be one or more of Advanced Micro Devices (AMD) Ryzen® processor(s) or Accelerated Processing Units (APUs); A5-A9 processor(s) from Apple® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc.; an ARM-based design licensed from ARM Holdings, Ltd.; or the like. In some implementations, the application circuitry XT05 may be a part of a system on a chip (SoC) in which the application circuitry XT05 and other components are formed into a single integrated circuit, or a single package, such as the Edison™ or Galileo™ SoC boards from Intel® Corporation.

Additionally or alternatively, application circuitry XT05 may include circuitry such as, but not limited to, one or more field-programmable devices (FPDs) such as FPGAs and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry XT05 may comprise logic blocks or logic fabric including other interconnected resources that may be programmed to perform various functions, such as the procedures, methods, functions, etc. of the various embodiments discussed herein. In such embodiments, the circuitry of application circuitry XT05 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in lookup-tables (LUTs) and the like.

The baseband circuitry XT10 may be implemented, for example, as a solder-down substrate including one or more integrated circuits, a single packaged integrated circuit soldered to a main circuit board or a multi-chip module containing two or more integrated circuits. Although not shown, baseband circuitry XT10 may comprise one or more digital baseband systems, which may be coupled via an interconnect subsystem to a CPU subsystem, an audio subsystem, and an interface subsystem. The digital baseband subsystems may also be coupled to a digital baseband interface and a mixed-signal baseband sub-system via another interconnect subsystem. Each of the interconnect subsystems may include a bus system, point-to-point connections, network-on-chip (NOC) structures, and/or some other suitable bus or interconnect technology, such as those discussed herein. The audio sub-system may include digital signal processing circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry XT10 may include protocol processing circuitry with one or more instances of control circuitry (not shown) to provide control functions for the digital baseband circuitry and/or radio frequency circuitry (for example, the radio front end modules XT15).

The radio front end modules (RFEMs) XT15 may comprise a millimeter wave RFEM and one or more sub-millimeter wave radio frequency integrated circuits (RFICs). In some implementations, the one or more sub-millimeter wave RFICs may be physically separated from the millimeter wave RFEM. The RFICs may include connections to one or more antennas or antenna arrays, and the RFEM may be connected to multiple antennas. In alternative implementations, both millimeter wave and sub-millimeter wave radio functions may be implemented in the same physical radio front end module XT15. The RFEMs XT15 may incorporate both millimeter wave antennas and sub-millimeter wave antennas.

The memory circuitry XT20 may include any number and type of memory devices used to provide for a given amount of system memory. As examples, the memory circuitry XT20 may include one or more of volatile memory including random access memory (RAM), dynamic RAM (DRAM) and/or synchronous dynamic RAM (SDRAM), and nonvolatile memory (NVM) including high-speed electrically erasable memory (commonly referred to as Flash memory), phase change random access memory (PRAM), magnetoresistive random access memory (MRAM), etc. The memory circuitry XT20 may be developed in accordance with a Joint Electron Devices Engineering Council (JEDEC) low power double data rate (LPDDR)-based design, such as LPDDR2, LPDDR3, LPDDR4, or the like. Memory circuitry XT20 may be implemented as one or more of solder down packaged integrated circuits, single die package (SDP), dual die package (DDP) or quad die package (Q17P), socketed memory modules, dual inline memory modules (DIMMs) including microDIMMs or MiniDIMMs, and/or soldered onto a motherboard via a ball grid array (BGA). In low power implementations, the memory circuitry XT20 may be on-die memory or registers associated with the application circuitry XT05. To provide for persistent storage of information such as data, applications, operating systems and so forth, memory circuitry XT20 may include one or more mass storage devices, which may include, inter alia, a solid state disk drive (SSDD), hard disk drive (HDD), a micro HDD, resistance change memories, phase change memories, holographic memories, or chemical memories, among others. For example, the computer platform XT00 may incorporate the three-dimensional (3D) cross-point (XPOINT) memories from Intel® and Micron®.

Removable memory circuitry XT23 may include devices, circuitry, enclosures/housings, ports or receptacles, etc. used to coupled portable data storage devices with the platform XT00. These portable data storage devices may be used for mass storage purposes, and may include, for example, flash memory cards (e.g., Secure Digital (SD) cards, microSD cards, xD picture cards, and the like), and USB flash drives, optical discs, external HDDs, and the like.

The platform XT00 may also include interface circuitry (not shown) that is used to connect external devices with the platform XT00. The external devices connected to the platform XT00 via the interface circuitry may include sensors XT21, such as accelerometers, level sensors, flow sensors, temperature sensors, pressure sensors, barometric pressure sensors, and the like. The interface circuitry may be used to connect the platform XT00 to electro-mechanical components (EMCs) XT22, which may allow platform XT00 to change its state, position, and/or orientation, or move or control a mechanism or system. The EMCs XT22 may include one or more power switches, relays including electromechanical relays (EMRs) and/or solid state relays (SSRs), actuators (e.g., valve actuators, etc.), an audible sound generator, a visual warning device, motors (e.g., DC motors, stepper motors, etc.), wheels, thrusters, propellers, claws, clamps, hooks, and/or other like electro-mechanical components. In embodiments, platform XT00 may be configured to operate one or more EMCs XT22 based on one or more captured events and/or instructions or control signals received from a service provider and/or various clients.

In some implementations, the interface circuitry may connect the platform XT00 with positioning circuitry XT45, which may be the same as or similar to the positioning circuitry XS45 discussed with regard to FIG. 8.

In some implementations, the interface circuitry may connect the platform XT00 with near-field communication (NFC) circuitry XT40, which may include an NFC controller coupled with an antenna element and a processing device. The NFC circuitry XT40 may be configured to read electronic tags and/or connect with another NFC-enabled device.

The driver circuitry XT46 may include software and hardware elements that operate to control particular devices that are embedded in the platform XT00, attached to the platform XT00, or otherwise communicatively coupled with the platform XT00. The driver circuitry XT46 may include individual drivers allowing other components of the platform XT00 to interact with or control various input/output (I/O) devices that may be present within, or connected to, the platform XT00. For example, driver circuitry XT46 may include a display driver to control and allow access to a display device, a touchscreen driver to control and allow access to a touchscreen interface of the platform XT00, sensor drivers to obtain sensor readings of sensors XT21 and control and allow access to sensors XT21, EMC drivers to obtain actuator positions of the EMCs XT22 and/or control and allow access to the EMCs XT22, a camera driver to control and allow access to an embedded image capture device, audio drivers to control and allow access to one or more audio devices.

The power management integrated circuitry (PMIC) XT25 (also referred to as “power management circuitry XT25”) may manage power provided to various components of the platform XT00. In particular, with respect to the baseband circuitry XT10, the PMIC XT25 may control power-source selection, voltage scaling, battery charging, or DC-to-DC conversion. The PMIC XT25 may often be included when the platform XT00 is capable of being powered by a battery XT30, for example, when the device is included in a UE XQ01, XQ02, XR01.

In some embodiments, the PMIC XT25 may control, or otherwise be part of, various power saving mechanisms of the platform XT00. For example, if the platform XT00 is in an RRC_Connected state, where it is still connected to the RAN node as it expects to receive traffic shortly, then it may enter a state known as Discontinuous Reception Mode (DRX) after a period of inactivity. During this state, the platform XT00 may power down for brief intervals of time and thus save power. If there is no data traffic activity for an extended period of time, then the platform XT00 may transition off to an RRC_Idle state, where it disconnects from the network and does not perform operations such as channel quality feedback, handover, etc. The platform XT00 goes into a very low power state and it performs paging where again it periodically wakes up to listen to the network and then powers down again. The platform XT00 may not receive data in this state, in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery XT30 may power the platform XT00, although in some examples the platform XT00 may be mounted deployed in a fixed location, and may have a power supply coupled to an electrical grid. The battery XT30 may be a lithium ion battery, a metal-air battery, such as a zinc-air battery, an aluminum-air battery, a lithium-air battery, and the like. In some implementations, such as in V2X applications, the battery XT30 may be a typical lead-acid automotive battery.

In some implementations, the battery XT30 may be a “smart battery,” which includes or is coupled with a Battery Management System (BMS) or battery monitoring integrated circuitry. The BMS may be included in the platform XT00 to track the state of charge (SoCh) of the battery XT30. The BMS may be used to monitor other parameters of the battery XT30 to provide failure predictions, such as the state of health (SoH) and the state of function (SoF) of the battery XT30. The BMS may communicate the information of the battery XT30 to the application circuitry XT05 or other components of the platform XT00. The BMS may also include an analog-to-digital (ADC) convertor that allows the application circuitry XT05 to directly monitor the voltage of the battery XT30 or the current flow from the battery XT30. The battery parameters may be used to determine actions that the platform XT00 may perform, such as transmission frequency, network operation, sensing frequency, and the like.

A power block, or other power supply coupled to an electrical grid, may be coupled with the BMS to charge the battery XT30. In some examples, the power block may be replaced with a wireless power receiver to obtain the power wirelessly, for example, through a loop antenna in the computer platform XT00. In these examples, a wireless battery charging circuit may be included in the BMS. The specific charging circuits chosen may depend on the size of the battery XT30, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

Although not shown, the components of platform XT00 may communicate with one another using a suitable bus technology, which may include any number of technologies, including industry standard architecture (ISA), extended ISA (EISA), peripheral component interconnect (PCI), peripheral component interconnect extended (PCIx), PCI express (PCIe), a Time-Trigger Protocol (TTP) system, a FlexRay system, or any number of other technologies. The bus may be a proprietary bus, for example, used in a SoC based system. Other bus systems may be included, such as an I²C interface, an SPI interface, point to point interfaces, and a power bus, among others.

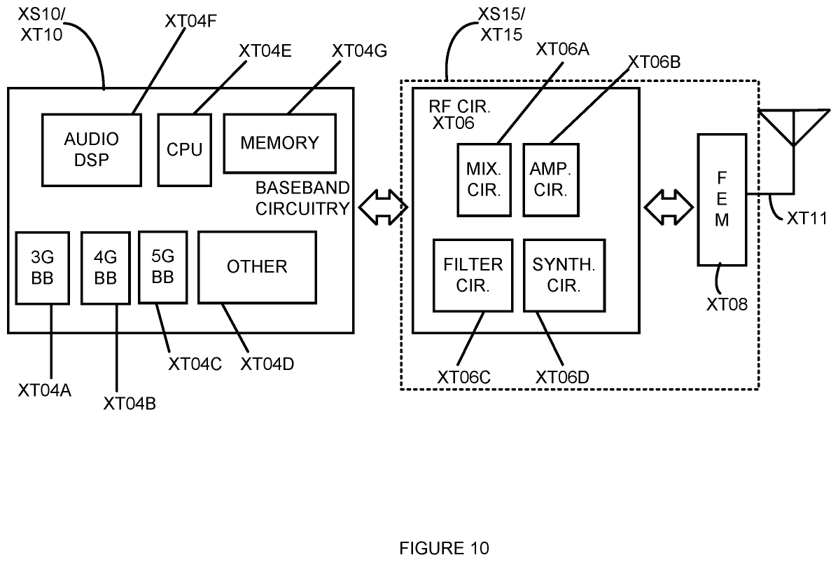

FIG. 10 illustrates example components of baseband circuitry XS10/XT10 and radio front end modules (RFEM) XS15/XT15 in accordance with some embodiments. As shown, the RFEM XS15/XT15 may include Radio Frequency (RF) circuitry XT06, front-end module (FEM) circuitry XT08, and/or one or more antennas XT11 coupled together at least as shown.

The baseband circuitry XS10/XT10 may include circuitry such as, but not limited to, one or more single-core or multi-core processors. The baseband circuitry XS10/XT10 may include one or more baseband processors or control logic to process baseband signals received from a receive signal path of the RF circuitry XT06 and to generate baseband signals for a transmit signal path of the RF circuitry XT06. Baseband processing circuitry XS10/XT10 may interface with the application circuitry XS05/XT05 for generation and processing of the baseband signals and for controlling operations of the RF circuitry XT06. For example, in some embodiments, the baseband circuitry XS10/XT10 may include a third generation (3G) baseband processor XT04A, a fourth generation (4G) baseband processor XT04B, a fifth generation (5G) baseband processor XT04C, or other baseband processor(s) XT04D for other existing generations, generations in development or to be developed in the future (e.g., second generation (2G), sixth generation (6G), etc.). The baseband circuitry XS10/XT10 (e.g., one or more of baseband processors XT04A-D) may handle various radio control functions that enable communication with one or more radio networks via the RF circuitry XT06. In other embodiments, some or all of the functionality of baseband processors XT04A-D may be included in modules stored in the memory XT04G and executed via a Central Processing Unit (CPU) XT04E. The radio control functions may include, but are not limited to, signal modulation/demodulation, encoding/decoding, radio frequency shifting, etc. In some embodiments, modulation/demodulation circuitry of the baseband circuitry XS10/XT10 may include Fast-Fourier Transform (FFT), precoding, or constellation mapping/demapping functionality. In some embodiments, encoding/decoding circuitry of the baseband circuitry XS10/XT10 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry XS10/XT10 may include one or more audio digital signal processor(s) (DSP) XT04F. The audio DSP(s) XT04F may be include elements for compression/decompression and echo cancellation and may include other suitable processing elements in other embodiments. Components of the baseband circuitry XS10/XT10 may be suitably combined in a single chip or a single chipset, or disposed on a same circuit board in some embodiments. In some embodiments, some or all of the constituent components of the baseband circuitry XS10/XT10 and the application circuitry XS05/XT05 may be implemented together such as, for example, on a system on a chip (SoC).

In some embodiments, the baseband circuitry XS10/XT10 may provide for communication compatible with one or more radio technologies. For example, in some embodiments, the baseband circuitry XS10/XT10 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry XS10/XT10 is configured to support radio communications of more than one wireless protocol may be referred to as multi-mode baseband circuitry.

RF circuitry XT06 may enable communication with wireless networks using modulated electromagnetic radiation through a non-solid medium. In various embodiments, the RF circuitry XT06 may include switches, filters, amplifiers, etc. to facilitate the communication with the wireless network. RF circuitry XT06 may include a receive signal path, which may include circuitry to down-convert RF signals received from the FEM circuitry XT08 and provide baseband signals to the baseband circuitry XS10/XT10. RF circuitry XT06 may also include a transmit signal path, which may include circuitry to up-convert baseband signals provided by the baseband circuitry XS10/XT10 and provide RF output signals to the FEM circuitry XT08 for transmission.

In some embodiments, the receive signal path of the RF circuitry XT06 may include mixer circuitry XT06a, amplifier circuitry XT06b and filter circuitry XT06c. In some embodiments, the transmit signal path of the RF circuitry XT06 may include filter circuitry XT06c and mixer circuitry XT06a. RF circuitry XT06 may also include synthesizer circuitry XT06d for synthesizing a frequency for use by the mixer circuitry XT06a of the receive signal path and the transmit signal path. In some embodiments, the mixer circuitry XT06a of the receive signal path may be configured to down-convert RF signals received from the FEM circuitry XT08 based on the synthesized frequency provided by synthesizer circuitry XT06d. The amplifier circuitry XT06b may be configured to amplify the down-converted signals and the filter circuitry XT06c may be a low-pass filter (LPF) or band-pass filter (BPF) configured to remove unwanted signals from the down-converted signals to generate output baseband signals. Output baseband signals may be provided to the baseband circuitry XS10/XT10 for further processing. In some embodiments, the output baseband signals may be zero-frequency baseband signals, although this is not a requirement. In some embodiments, mixer circuitry XT06a of the receive signal path may comprise passive mixers, although the scope of the embodiments is not limited in this respect.

In some embodiments, the mixer circuitry XT06a of the transmit signal path may be configured to up-convert input baseband signals based on the synthesized frequency provided by the synthesizer circuitry XT06d to generate RF output signals for the FEM circuitry XT08. The baseband signals may be provided by the baseband circuitry XS10/XT10 and may be filtered by filter circuitry XT06c.

In some embodiments, the mixer circuitry XT06a of the receive signal path and the mixer circuitry XT06a of the transmit signal path may include two or more mixers and may be arranged for quadrature downconversion and upconversion, respectively. In some embodiments, the mixer circuitry XT06a of the receive signal path and the mixer circuitry XT06a of the transmit signal path may include two or more mixers and may be arranged for image rejection (e.g., Hartley image rejection). In some embodiments, the mixer circuitry XT06a of the receive signal path and the mixer circuitry XT06a of the transmit signal path may be arranged for direct downconversion and direct upconversion, respectively. In some embodiments, the mixer circuitry XT06a of the receive signal path and the mixer circuitry XT06a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry XT06 may include analog-to-digital converter (ADC) and digital-to-analog converter (DAC) circuitry and the baseband circuitry XS10/XT10 may include a digital baseband interface to communicate with the RF circuitry XT06.

In some dual-mode embodiments, a separate radio IC circuitry may be provided for processing signals for each spectrum, although the scope of the embodiments is not limited in this respect.

In some embodiments, the synthesizer circuitry XT06d may be a fractional-N synthesizer or a fractional N/N+1 synthesizer, although the scope of the embodiments is not limited in this respect as other types of frequency synthesizers may be suitable. For example, synthesizer circuitry XT06d may be a delta-sigma synthesizer, a frequency multiplier, or a synthesizer comprising a phase-locked loop with a frequency divider.

The synthesizer circuitry XT06d may be configured to synthesize an output frequency for use by the mixer circuitry XT06a of the RF circuitry XT06 based on a frequency input and a divider control input. In some embodiments, the synthesizer circuitry XT06d may be a fractional N/N+1 synthesizer.

In some embodiments, frequency input may be provided by a voltage controlled oscillator (VCO), although that is not a requirement. Divider control input may be provided by either the baseband circuitry XS10/XT10 or the applications processor XS05/XT05 depending on the desired output frequency. In some embodiments, a divider control input (e.g., N) may be determined from a look-up table based on a channel indicated by the applications processor XS05/XT05.

Synthesizer circuitry XT06d of the RF circuitry XT06 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry XT06d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry XT06 may include an IQ/polar converter.

FEM circuitry XT08 may include a receive signal path, which may include circuitry configured to operate on RF signals received from one or more antennas XT11, amplify the received signals and provide the amplified versions of the received signals to the RF circuitry XT06 for further processing. FEM circuitry XT08 may also include a transmit signal path, which may include circuitry configured to amplify signals for transmission provided by the RF circuitry XT06 for transmission by one or more of the one or more antennas XT11. In various embodiments, the amplification through the transmit or receive signal paths may be done solely in the RF circuitry XT06, solely in the FEM XT08, or in both the RF circuitry XT06 and the FEM XT08.

In some embodiments, the FEM circuitry XT08 may include a TX/RX switch to switch between transmit mode and receive mode operation. The FEM circuitry XT08 may include a receive signal path and a transmit signal path. The receive signal path of the FEM circuitry XT08 may include an LNA to amplify received RF signals and provide the amplified received RF signals as an output (e.g., to the RF circuitry XT06). The transmit signal path of the FEM circuitry XT08 may include a power amplifier (PA) to amplify input RF signals (e.g., provided by RF circuitry XT06), and one or more filters to generate RF signals for subsequent transmission (e.g., by one or more of the one or more antennas XT11).

Processors of the application circuitry XS05/XT05 and processors of the baseband circuitry XS10/XT10 may be used to execute elements of one or more instances of a protocol stack. For example, processors of the baseband circuitry XS10/XT10, alone or in combination, may be used to execute Layer 3, Layer 2, or Layer 1 functionality, while processors of the baseband circuitry XS10/XT10 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

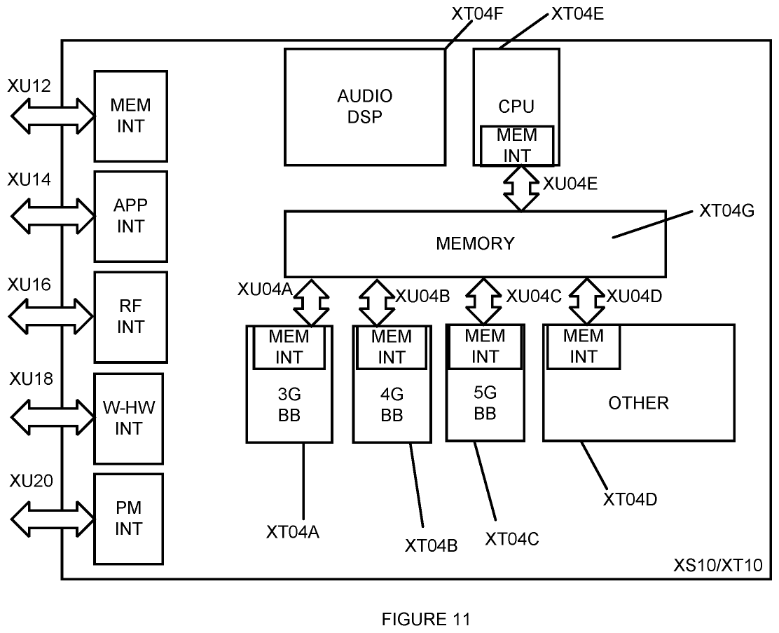

FIG. 11 illustrates example interfaces of baseband circuitry in accordance with some embodiments. As discussed above, the baseband circuitry XS10/XT10 of FIGS. 7-8 may comprise processors XT04A-XT04E and a memory XT04G utilized by said processors. Each of the processors XT04A-XT04E may include a memory interface, XU04A-XU04E, respectively, to send/receive data to/from the memory XT04G.

The baseband circuitry XS10/XT10 may further include one or more interfaces to communicatively couple to other circuitries/devices, such as a memory interface XU12 (e.g., an interface to send/receive data to/from memory external to the baseband circuitry XS10/XT10), an application circuitry interface XU14 (e.g., an interface to send/receive data to/from the application circuitry XS05/XT05 of FIGS. 7-8), an RF circuitry interface XU16 (e.g., an interface to send/receive data to/from RF circuitry XT06 of FIG. 10), a wireless hardware connectivity interface XU18 (e.g., an interface to send/receive data to/from Near Field Communication (NFC) components, Bluetooth® components (e.g., Bluetooth® Low Energy), Wi-Fi® components, and other communication components), and a power management interface XU20 (e.g., an interface to send/receive power or control signals to/from the PMIC XT25.

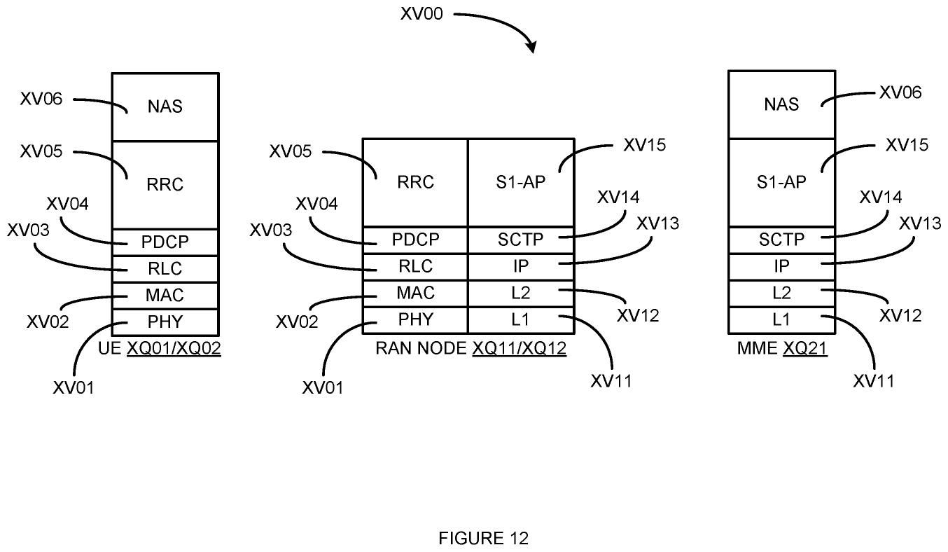

FIG. 12 is an illustration of a control plane protocol stack in accordance with some embodiments. In this embodiment, a control plane XV00 is shown as a communications protocol stack between the UE XQ01 (or alternatively, the UE XQ02), the RAN node XQ11 (or alternatively, the RAN node XQ12), and the MME XQ21.

The PHY layer XV01 may transmit or receive information used by the MAC layer XV02 over one or more air interfaces. The PHY layer XV01 may further perform link adaptation or adaptive modulation and coding (AMC), power control, cell search (e.g., for initial synchronization and handover purposes), and other measurements used by higher layers, such as the RRC layer XV05. The PHY layer XV01 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer XV02 may perform mapping between logical channels and transport channels, multiplexing of MAC service data units (SDUs) from one or more logical channels onto transport blocks (TB) to be delivered to the PHY layer XV01 via transport channels, de-multiplexing MAC SDUs to one or more logical channels from transport blocks (TB) delivered from the PHY layer XV01 via transport channels, multiplexing MAC SDUs onto TBs, scheduling information reporting, error correction through hybrid automatic repeat request (HARQ), and logical channel prioritization.

The RLC layer XV03 may operate in a plurality of modes of operation, including: Transparent Mode (TM), Unacknowledged Mode (UM), and Acknowledged Mode (AM). The RLC layer XV03 may execute transfer of upper layer protocol data units (PDUs), error correction through automatic repeat request (ARQ) for AM data transfers, and concatenation, segmentation and reassembly of RLC SDUs for UM and AM data transfers. The RLC layer XV03 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer XV04 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer XV05 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE XQ01 and the RAN node XQ11 may utilize a Uu interface (e.g., an LTE-Uu interface) to exchange control plane data via a protocol stack comprising the PHY layer XV01, the MAC layer XV02, the RLC layer XV03, the PDCP layer XV04, and the RRC layer XV05.

The non-access stratum (NAS) protocols XV06 form the highest stratum of the control plane between the UE XQ01 and the MME XQ21. The NAS protocols XV06 support the mobility of the UE XQ01 and the session management procedures to establish and maintain IP connectivity between the UE XQ01 and the P-GW XQ23.

The S1 Application Protocol (S1-AP) layer XV15 may support the functions of the S1 interface and comprise Elementary Procedures (EPs). An EP is a unit of interaction between the RAN node XQ11 and the CN XQ20. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) XV14 may ensure reliable delivery of signaling messages between the RAN node XQ11 and the MME XQ21 based, in part, on the IP protocol, supported by the IP layer XV13. The L2 layer XV12 and the L1 layer XV11 may refer to communication links (e.g., wired or wireless) used by the RAN node and the MME to exchange information.

The RAN node XQ11 and the MME XQ21 may utilize an S1-MME interface to exchange control plane data via a protocol stack comprising the L1 layer XV11, the L2 layer XV12, the IP layer XV13, the SCTP layer XV14, and the S1-AP layer XV15.

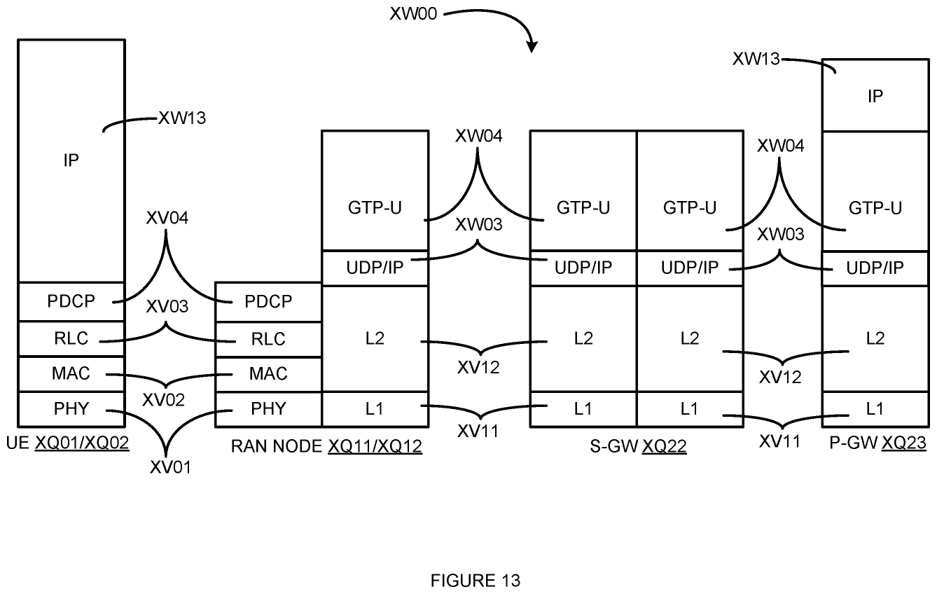

FIG. 13 is an illustration of a user plane protocol stack in accordance with some embodiments. In this embodiment, a user plane XW00 is shown as a communications protocol stack between the UE XQ01 (or alternatively, the UE XQ02), the RAN node XQ11 (or alternatively, the RAN node XQ12), the S-GW XQ22, and the P-GW XQ23. The user plane XW00 may utilize at least some of the same protocol layers as the control plane XV00. For example, the UE XQ01 and the RAN node XQ11 may utilize a Uu interface (e.g., an LTE-Uu interface) to exchange user plane data via a protocol stack comprising the PHY layer XV01, the MAC layer XV02, the RLC layer XV03, the PDCP layer XV04.

The General Packet Radio Service (GPRS) Tunneling Protocol for the user plane (GTP-U) layer XW04 may be used for carrying user data within the GPRS core network and between the radio access network and the core network. The user data transported can be packets in any of IPv4, IPv6, or PPP formats, for example. The UDP and IP security (UDP/IP) layer XW03 may provide checksums for data integrity, port numbers for addressing different functions at the source and destination, and encryption and authentication on the selected data flows. The RAN node XQ11 and the S-GW XQ22 may utilize an S1-U interface to exchange user plane data via a protocol stack comprising the L1 layer XV11, the L2 layer XV12, the UDP/IP layer XW03, and the GTP-U layer XW04. The S-GW XQ22 and the P-GW XQ23 may utilize an S5/S8a interface to exchange user plane data via a protocol stack comprising the L1 layer XV11, the L2 layer XV12, the UDP/IP layer XW03, and the GTP-U layer XW04. As discussed above with respect to FIG. 12, NAS protocols support the mobility of the UE XQ01 and the session management procedures to establish and maintain IP connectivity between the UE XQ01 and the P-GW XQ23.

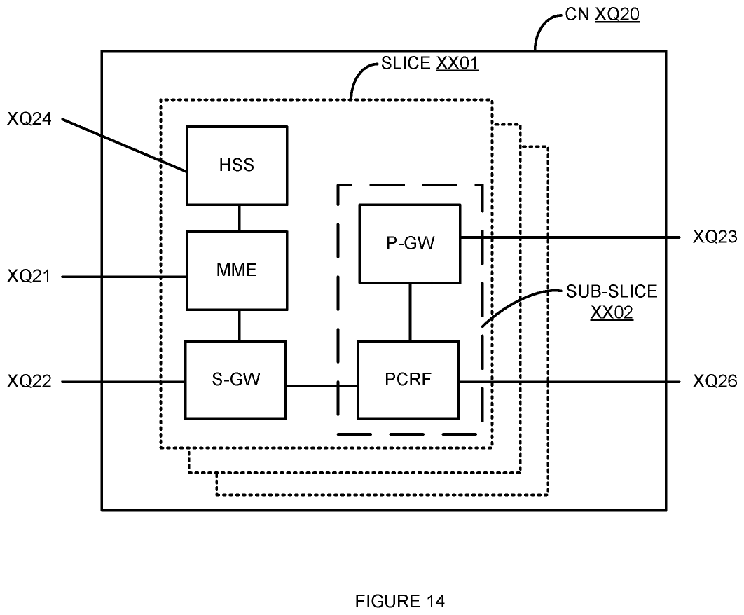

FIG. 14 illustrates components of a core network in accordance with some embodiments. The components of the CN XQ20 may be implemented in one physical node or separate physical nodes including components to read and execute instructions from a machine-readable or computer-readable medium (e.g., a non-transitory machine-readable storage medium). In embodiments, the components of CN XR20 may be implemented in a same or similar manner as discussed herein with regard to the components of CN XQ20. In some embodiments, Network Functions Virtualization (NFV) is utilized to virtualize any or all of the above described network node functions via executable instructions stored in one or more computer readable storage mediums (described in further detail below). A logical instantiation of the CN XQ20 may be referred to as a network slice XX01, and individual logical instantiations of the CN XQ20 may provide specific network capabilities and network characteristics. A logical instantiation of a portion of the CN XQ20 may be referred to as a network sub-slice XX02 (e.g., the network sub-slice XX02 is shown to include the PGW XQ23 and the PCRF XQ26).

As used herein, the terms “instantiate”, “instantiation”, and the like may refer to the creation of an instance, and an “instance” may refer to a concrete occurrence of an object, which may occur, for example, during execution of program code. A network instance may refer to information identifying a domain, which may be used for traffic detection and routing in case of different IP domains or overlapping IP addresses. A network slice instance may refer to a set of network functions (NFs) instances and the resources (e.g., compute, storage, and networking resources) required to deploy the network slice.

With respect to 5G systems (see, e.g., FIG. 7), a network slice may include the CN control plane and user plane NFs, NG RANs in a serving PLMN, and a N3IWF functions in the serving PLMN. Individual network slices may have different Single Network Slice Selection Assistance Information (S-NSSAI) and/or may have different Slice/Service Types (SSTs). Network slices may differ for supported features and network functions optimizations, and/or multiple network slice instances may deliver the same service/features but for different groups of UEs (e.g., enterprise users). For example, individual network slices may deliver different committed service(s) and/or may be dedicated to a particular customer or enterprise. In this example, each network slice may have different S-NSSAIs with the same SST but with different slice differentiators. Additionally, a single UE may be served with one or more network slice instances simultaneously via a 5G access node (AN) and associated with eight different S-NSSAIs. Moreover, an AMF instance serving an individual UE may belong to each of the network slice instances serving that UE.

NFV architectures and infrastructures may be used to virtualize one or more NFs, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

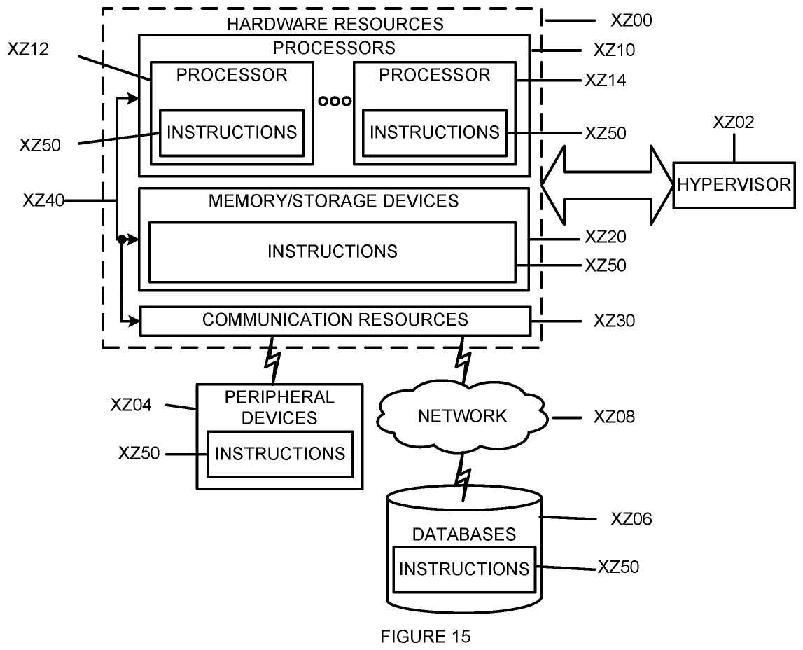

FIG. 15 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources XZ00 including one or more processors (or processor cores) XZ10, one or more memory/storage devices XZ20, and one or more communication resources XZ30, each of which may be communicatively coupled via a bus XZ40. As used herein, the term “computing resource”, “hardware resource”, etc., may refer to a physical or virtual device, a physical or virtual component within a computing environment, and/or a physical or virtual component within a particular device, such as computer devices, mechanical devices, memory space, processor/CPU time and/or processor/CPU usage, processor and accelerator loads, hardware time or usage, electrical power, input/output operations, ports or network sockets, channel/link allocation, throughput, memory usage, storage, network, database and applications, and/or the like. For embodiments where node virtualization (e.g., NFV) is utilized, a hypervisor XZ02 may be executed to provide an execution environment for one or more network slices/sub-slices to utilize the hardware resources)(ZOO. A “virtualized resource” may refer to compute, storage, and/or network resources provided by virtualization infrastructure to an application, device, system, etc. The processors XZ10 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor XZ12 and a processor XZ14.

The memory/storage devices XZ20 may include main memory, disk storage, or any suitable combination thereof. The memory/storage devices XZ20 may include, but are not limited to, any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources XZ30 may include interconnection or network interface components or other suitable devices to communicate with one or more peripheral devices XZ04 or one or more databases XZ06 via a network XZ08. For example, the communication resources XZ30 may include wired communication components (e.g., for coupling via a Universal Serial Bus (USB)), cellular communication components, NFC components, Bluetooth® components (e.g., Bluetooth® Low Energy), Wi-Fi® components, and other communication components. As used herein, the term “network resource” or “communication resource” may refer to computing resources that are accessible by computer devices via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

Instructions XZ50 may comprise software, a program, an application, an applet, an app, or other executable code for causing at least any of the processors XZ10 to perform any one or more of the methodologies discussed herein. The instructions XZ50 may reside, completely or partially, within at least one of the processors XZ10 (e.g., within the processor's cache memory), the memory/storage devices XZ20, or any suitable combination thereof. Furthermore, any portion of the instructions XZ50 may be transferred to the hardware resources XZ00 from any combination of the peripheral devices XZ04 or the databases XZ06. Accordingly, the memory of processors XZ10, the memory/storage devices XZ20, the peripheral devices XZ04, and the databases XZ06 are examples of computer-readable and machine-readable media.

Example 1 may include an apparatus for an evolved NodeB (eNB), comprising circuitry to determine one or more candidate eNBs available to provide service to a user equipment (UE) based on cell information received from one or more other eNBs, and generate an autonomous handover (HO) information message for transmission to the UE, wherein the autonomous HO information message includes an indication of the one or more candidate eNBs, and memory to store the indication of the one or more candidate eNBs.

Example 2 may include the apparatus of example 1 or any other example herein, wherein the indication of the one or more candidate eNBs comprises a list of identifiers of the one or more candidate eNBs.

Example 3 may include the apparatus of example 1 or any other example herein, wherein to determine the one or more candidate eNBs includes to identify a predetermined number of the one or more other eNBs to be the one or more candidate eNBs based on the cell information.

Example 4 the apparatus of example 1 or any other example herein, wherein the cell information includes a number of UEs connected to each of the one or more other eNBs, an amount of traffic being serviced by each of the one or more other eNBs, or a predicted quality of service level between each of the one or more other eNBs and the UE.

Example 5 may include the apparatus of example 1 or any other example herein, wherein the autonomous HO information message further includes an indication of whether the autonomous HO information message was generated in response to a measurement report.

Example 6 may include the apparatus of claim 1, wherein the circuitry is further to identify a measurement report received from the UE, wherein the measurement report indicates connectivity information of the UE with proximate eNBs, update the one or more candidate eNBs based on the connectivity information, and generate a second autonomous HO information message for transmission to the UE, wherein the second autonomous HO information message includes an indication of the updated one or more candidate eNBs, and the memory is further to store the indication of the updated one or more candidate eNBs.

Example 7 may include the apparatus of example 6 or any other example herein, wherein the second autonomous HO information message includes an indication that the UE is to restart an autonomous HO timer.

Example 8 may include the apparatus of example 6 or any other example herein, wherein the second autonomous HO information message further includes an indication that the second autonomous HO information message was generated in response to the measurement report.

Example 9 may include the apparatus of claim 6, wherein the circuitry is further to determine a target eNB to which to transfer service for the UE, and generate an HO command for transmission to the UE, wherein the HO command includes an indication of the target eNB.

Example 10 may include one or more computer-readable media having instructions stored thereon, wherein the instructions, in response to execution by an evolved NodeB (eNB), cause the eNB to identify one or more candidate eNBs available to provide service for a UE based on information received from the one or more candidate eNBs, the UE connected to the eNB, generate an autonomous handover (HO) information message that includes an indication of the one or more candidate eNBs, and encode the autonomous HO information message for transmission to the UE.

Example 11 may include the one or more computer-readable media of example 10 or any other example herein, wherein the indication of the one or more candidate eNBs includes a list of identifiers of the one or more candidate eNBs.

Example 12 may include the one or more computer-readable media of example 10 or any other example herein, wherein the candidate eNBs are identified from a plurality of eNBs that have provided cell information to the eNB.

Example 13 may include the one or more computer-readable media of example 10 or any other example herein, wherein the information received from the one or more candidate eNBs includes a number of UEs connected to each of the one or more candidate eNBs, an amount of traffic being serviced by each of the one or more candidate eNBs, or a predicted quality of service level between each of the one or more candidate eNBs and the UE.

Example 14 may include the one or more computer-readable media of example 10 or any other example herein, wherein the instructions further cause the eNB to identify a measurement report received from the UE, wherein the measurement report indicates connectivity information of the UE with proximate eNBs, update the one or more candidate eNBs based on the connectivity information, generate a second autonomous HO information message that includes an indication of the updated one or more candidate eNBs, and encode the second autonomous HO information message for transmission to the UE.

Example 15 may include the one or more computer-readable media of example 14 or any other example herein, wherein the second autonomous HO information message includes an indication that the UE is to restart an autonomous HO timer.

Example 16 may include the one or more computer-readable media of example 14 or any other example herein, wherein the instructions further cause the eNB to select a target eNB from the one or more candidate eNBs, encode an HO request for transmission to the target eNB, generate an HO command in response to identification of an HO request acknowledgement received from the target eNB, wherein the HO command indicates that the UE is to connect to the target eNB, and encode the HO command for transmission to the UE.

Example 17 may include an apparatus for a user equipment (UE), comprising memory to store an indication of one or more candidate evolved NodeBs (eNBs) based on an autonomous handover (HO) information message received from a source eNB, and circuitry to identify the indication of the one or more candidate eNBs in the autonomous HO information message received from the source eNB, encode a measurement report for transmission to the source eNB after reception of the autonomous HO information message, and perform an HO operation based on the measurement report.

Example 18 may include the apparatus of example 17 or any other example herein, wherein the circuitry is further to start an autonomous HO timer counting from an initial value in response to transmission of the measurement report, and determine whether an HO command is received prior to expiration of the autonomous HO timer, wherein the HO operation depends on whether the HO command is received prior to expiration of the autonomous HO timer.

Example 19 may include the apparatus of example 18 or any other example herein, wherein the circuitry determines that the HO command is not received prior to expiration of the autonomous HO timer, wherein the circuitry is further to select the target eNB from the one or more candidate eNBs, and wherein the HO operation comprises the UE establishing a connection with the target eNB.

Example 20 may include the apparatus of example 18 or any other example herein, wherein the circuitry is further to identify an indication that the UE is to restart the autonomous HO timer received in a subsequent autonomous HO information message from the source eNB, and restart the autonomous HO timer counting from the initial value in response to identification of the indication that the UE is to restart the autonomous HO timer.

Example 21 may include the apparatus of example or any other example herein, wherein the first circuitry determines that the HO command is received prior to the expiration of the autonomous HO timer, wherein the circuitry is further to identify an indication of the target eNB within the HO command, and wherein the HO operation comprises the UE establishing a connection with the target eNB.

Example 22 may include one or more computer-readable media having instructions stored thereon, wherein the instructions, in response to execution by a user equipment (UE), cause the UE to identify an indication of one or more candidate evolved NodeBs (eNBs) within an autonomous handover (HO) information message received from a source eNB, encode a measurement report for transmission to the source eNB after reception of the autonomous HO information message, start an autonomous HO timer in response to the transmission of the measurement report, determine whether an HO command is received prior to expiration of the autonomous HO timer, and perform an HO operation, wherein the HO operation is dependent on whether the HO command is received prior to the expiration of the autonomous HO timer.

Example 23 may include the one or more computer-readable media of example 22 or any other example herein, wherein the UE determines that the HO command is not received prior to the expiration of the autonomous HO timer, wherein the instructions further cause the UE to select a target eNB from the one or more candidate eNBs, and wherein the HO operation comprises the UE establishing a connection with the target eNB.

Example 24 may include the one or more computer-readable media of example 22 or any other example herein, wherein the UE determines that the HO command is received prior to the expiration of the autonomous HO timer, wherein the instructions further cause the UE to identify an indication of a target eNB within the HO command, and wherein the HO operation comprises the UE establishing a connection with the target eNB.

Example 25 may include the one or more computer-readable media of example 22 or any other example herein, wherein the instructions further cause UE to identify an indication that the UE is to restart the autonomous HO timer from a particular value within a subsequent autonomous HO information message received from the source eNB after transmission of the measurement report, and restart the HO timer from the particular value in response to identification of the indication that the UE is to restart the autonomous HO timer.

Example 26 may include a method to be performed by an evolved NodeB (eNB), comprising determining or causing to determine one or more candidate eNBs available to provide service to a user equipment (UE) based on cell information received from one or more other eNBs, generating or causing to generate an autonomous handover (HO) information message for transmission to the UE, wherein the autonomous HO information message includes an indication of the one or more candidate eNBs, and storing or causing to store the indication of the one or more candidate eNBs.

Example 27 may include the method of claim 26, wherein the indication of the one or more candidate eNBs comprises a list of identifiers of the one or more candidate eNBs.

Example 28 may include the method of claim 26, wherein determining or causing to determine the one or more candidate eNBs includes identifying or causing to identify a predetermined number of the one or more other eNBs to be the one or more candidate eNBs based on the cell information.

Example 29 may include the method of claim 26, wherein the cell information includes a number of UEs connected to each of the one or more other eNBs, an amount of traffic being serviced by each of the one or more other eNBs, or a predicted quality of service level between each of the one or more other eNBs and the UE.

Example 30 may include the method of claim 26, wherein the autonomous HO information message further includes an indication of whether the autonomous HO information message was generated in response to a measurement report.

Example 31 may include the method of claim 26, further comprising identifying or causing to identify a measurement report received from the UE, wherein the measurement report indicates connectivity information of the UE with proximate eNBs, updating or causing to update the one or more candidate eNBs based on the connectivity information, generating or causing to generate a second autonomous HO information message for transmission to the UE, wherein the second autonomous HO information message includes an indication of the updated one or more candidate eNBs, and storing or causing to store the indication of the updated one or more candidate eNBs.

Example 32 may include the method of claim 31, wherein the second autonomous HO information message includes an indication that the UE is to restart an autonomous HO timer.

Example 33 may include the method of claim 31, wherein the second autonomous HO information message further includes an indication that the second autonomous HO information message was generated in response to the measurement report.

Example 34 may include the method of claim 31, wherein determining or causing to determine a target eNB to which to transfer service for the UE, and generating or causing to generate an HO command for transmission to the UE, wherein the HO command includes an indication of the target eNB.

Example 35 may include a method to be performed by an evolved NodeB (eNB), comprising identifying or causing to identify one or more candidate eNBs available to provide service for a UE based on information received from the one or more candidate eNBs, the UE connected to the eNB, generating or causing to generate an autonomous handover (HO) information message that includes an indication of the one or more candidate eNBs, and encoding or causing to encode the autonomous HO information message for transmission to the UE.

Example 36 may include the method of claim 35, wherein the indication of the one or more candidate eNBs includes a list of identifiers of the one or more candidate eNBs.

Example 37 may include the method of claim 35, wherein the candidate eNBs are identified from a plurality of eNBs that have provided cell information to the eNB.

Example 38 may include the method of claim 35, wherein the information received from the one or more candidate eNBs includes a number of UEs connected to each of the one or more candidate eNBs, an amount of traffic being serviced by each of the one or more candidate eNBs, or a predicted quality of service level between each of the one or more candidate eNBs and the UE.

Example 39 may include the method of claim 35, further comprising identifying or causing to identify a measurement report received from the UE, wherein the measurement report indicates connectivity information of the UE with proximate eNBs, updating or causing to update the one or more candidate eNBs based on the connectivity information, generating or causing to generate a second autonomous HO information message that includes an indication of the updated one or more candidate eNBs, and encoding or causing to encode the second autonomous HO information message for transmission to the UE.

Example 40 may include the method of claim 39, wherein the second autonomous HO information message includes an indication that the UE is to restart an autonomous HO timer.

Example 41 may include the method of claim 39, further comprising selecting or causing to select a target eNB from the one or more candidate eNBs, encoding or causing to encode an HO request for transmission to the target eNB, generating or causing to generate an HO command in response to identification of an HO request acknowledgement received from the target eNB, wherein the HO command indicates that the UE is to connect to the target eNB, and encoding or causing to encode the HO command for transmission to the UE.

Example 42 may include a method to be performed by a user equipment (UE), comprising storing or causing to store an indication of one or more candidate evolved NodeBs (eNBs) based on an autonomous handover (HO) information message received from a source eNB, identifying or causing to identify the indication of the one or more candidate eNBs in the autonomous HO information message received from the source eNB, encoding or causing to encode a measurement report for transmission to the source eNB after reception of the autonomous HO information message, and performing or causing to perform an HO operation based on the measurement report.

Example 43 may include the method of claim 42, further comprising starting or causing to start an autonomous HO timer counting from an initial value in response to transmission of the measurement report, and determining or causing to determine whether an HO command is received prior to expiration of the autonomous HO timer, wherein the HO operation depends on whether the HO command is received prior to expiration of the autonomous HO timer.

Example 44 may include the method of claim 43, wherein the circuitry determines that the HO command is not received prior to expiration of the autonomous HO timer, wherein the method further comprises selecting or causing to select the target eNB from the one or more candidate eNBs, and wherein the HO operation comprises the UE establishing a connection with the target eNB.

Example 45 may include the method of claim 43, further comprising identifying or causing to identify an indication that the UE is to restart the autonomous HO timer received in a subsequent autonomous HO information message from the source eNB, and restarting or causing to restart the autonomous HO timer counting from the initial value in response to identification of the indication that the UE is to restart the autonomous HO timer.

Example 46 may include the method of claim 43, wherein the first circuitry determines that the HO command is received prior to the expiration of the autonomous HO timer, wherein the method further comprises identifying or causing to identify an indication of the target eNB within the HO command, and wherein the HO operation comprises the UE establishing a connection with the target eNB.

Example 47 may include a method to be performed by a user equipment (UE), comprising identifying or causing to identify an indication of one or more candidate evolved NodeBs (eNBs) within an autonomous handover (HO) information message received from a source eNB, encoding or causing to encode a measurement report for transmission to the source eNB after reception of the autonomous HO information message, starting or causing to start an autonomous HO timer in response to the transmission of the measurement report, determining or causing to determine whether an HO command is received prior to expiration of the autonomous HO timer, and performing or causing to perform an HO operation, wherein the HO operation is dependent on whether the HO command is received prior to the expiration of the autonomous HO timer.

Example 48 may include the method of claim 47, wherein the UE determines that the HO command is not received prior to the expiration of the autonomous HO timer, wherein the method further comprises selecting or causing to select a target eNB from the one or more candidate eNBs, and wherein the HO operation comprises the UE establishing a connection with the target eNB.

Example 49 may include the method of claim 47, wherein the UE determines that the HO command is received prior to the expiration of the autonomous HO timer, wherein the method further comprises identifying or causing to identify an indication of a target eNB within the HO command, and wherein the HO operation comprises the UE establishing a connection with the target eNB.

Example 50 may include the method of claim 47, further comprising identifying or causing to identify an indication that the UE is to restart the autonomous HO timer from a particular value within a subsequent autonomous HO information message received from the source eNB after transmission of the measurement report, and restarting or causing to restart the HO timer from the particular value in response to identification of the indication that the UE is to restart the autonomous HO timer.

Example 51 may include an apparatus to perform the method of any of examples 26-50.

Example 52 may include means to perform the method of any of examples 26-50.

Example 53 may include one or more computer-readable media having instructions stored thereon, wherein the instructions, in response to execution by an apparatus, cause the apparatus to perform the method of any of examples 26-50.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

1. An apparatus for an evolved NodeB (eNB), comprising:
circuitry to:
determine one or more candidate eNBs available to provide service to a user equipment (UE) based on cell information received from one or more other eNBs; and
generate an autonomous handover (HO) information message for transmission to the UE, wherein the autonomous HO information message includes an indication of the one or more candidate eNBs; and
memory to store the indication of the one or more candidate eNBs.

2. The apparatus of claim 1, wherein the indication of the one or more candidate eNBs comprises a list of identifiers of the one or more candidate eNBs.

3. The apparatus of claim 1, wherein to determine the one or more candidate eNBs includes to identify a predetermined number of the one or more other eNBs to be the one or more candidate eNBs based on the cell information.

4. The apparatus of claim 1, wherein the cell information includes a number of UEs connected to each of the one or more other eNBs, an amount of traffic being serviced by each of the one or more other eNBs, or a predicted quality of service level between each of the one or more other eNBs and the UE.

5. The apparatus of claim 1, wherein the autonomous HO information message further includes an indication of whether the autonomous HO information message was generated in response to a measurement report.

6. The apparatus of claim 1, wherein:
the circuitry is further to:
identify a measurement report received from the UE, wherein the measurement report indicates connectivity information of the UE with proximate eNBs;
update the one or more candidate eNBs based on the connectivity information; and
generate a second autonomous HO information message for transmission to the UE, wherein the second autonomous HO information message includes an indication of the updated one or more candidate eNBs; and
the memory is further to store the indication of the updated one or more candidate eNBs.

7. The apparatus of claim 6, wherein the second autonomous HO information message includes an indication that the UE is to restart an autonomous HO timer.

8. The apparatus of claim 6, wherein the second autonomous HO information message further includes an indication that the second autonomous HO information message was generated in response to the measurement report.

9. The apparatus of claim 6, wherein the circuitry is further to:
determine a target eNB to which to transfer service for the UE; and
generate an HO command for transmission to the UE, wherein the HO command includes an indication of the target eNB.

10. One or more non-transitory, computer-readable media having instructions stored thereon, wherein the instructions, in response to execution by an evolved NodeB (eNB), cause the eNB to:
identify one or more candidate eNBs available to provide service for a UE based on information received from the one or more candidate eNBs, the UE connected to the eNB;
generate an autonomous handover (HO) information message that includes an indication of the one or more candidate eNBs; and
encode the autonomous HO information message for transmission to the UE.

11. The one or more non-transitory, computer-readable media of claim 10, wherein the indication of the one or more candidate eNBs includes a list of identifiers of the one or more candidate eNBs.

12. The one or more non-transitory, computer-readable media of claim 10, wherein the candidate eNBs are identified from a plurality of eNBs that have provided cell information to the eNB.

13. The one or more non-transitory, computer-readable media of claim 10, wherein the information received from the one or more candidate eNBs includes a number of UEs connected to each of the one or more candidate eNBs, an amount of traffic being serviced by each of the one or more candidate eNBs, or a predicted quality of service level between each of the one or more candidate eNBs and the UE.

14. The one or more non-transitory, computer-readable media of claim 10, wherein the instructions further cause the eNB to:
identify a measurement report received from the UE, wherein the measurement report indicates connectivity information of the UE with proximate eNBs;
update the one or more candidate eNBs based on the connectivity information;
generate a second autonomous HO information message that includes an indication of the updated one or more candidate eNBs; and
encode the second autonomous HO information message for transmission to the UE.

15. The one or more non-transitory, computer-readable media of claim 14, wherein the second autonomous HO information message includes an indication that the UE is to restart an autonomous HO timer.

16. The one or more non-transitory, computer-readable media of claim 14, wherein the instructions further cause the eNB to:
select a target eNB from the one or more candidate eNBs;
encode an HO request for transmission to the target eNB;
generate an HO command in response to identification of an HO request acknowledgement received from the target eNB, wherein the HO command indicates that the UE is to connect to the target eNB; and
encode the HO command for transmission to the UE.

17. An apparatus for a user equipment (UE), comprising:
memory to store an indication of one or more candidate evolved NodeBs (eNBs) based on an autonomous handover (HO) information message received from a source eNB; and
circuitry to:
identify the indication of the one or more candidate eNBs in the autonomous HO information message received from the source eNB;
encode a measurement report for transmission to the source eNB after reception of the autonomous HO information message; and
perform an HO operation based on the measurement report.

18. The apparatus of claim 17, wherein the circuitry is further to:
start an autonomous HO timer counting from an initial value in response to transmission of the measurement report; and
determine whether an HO command is received prior to expiration of the autonomous HO timer, wherein the HO operation depends on whether the HO command is received prior to expiration of the autonomous HO timer.

19. The apparatus of claim 18, wherein the circuitry determines that the HO command is not received prior to expiration of the autonomous HO timer, wherein the circuitry is further to select a target eNB from the one or more candidate eNBs, and wherein the HO operation comprises the UE establishing a connection with the target eNB.

20. The apparatus of claim 18, wherein the circuitry is further to:
identify an indication that the UE is to restart the autonomous HO timer received in a subsequent autonomous HO information message from the source eNB; and
restart the autonomous HO timer counting from the initial value in response to identification of the indication that the UE is to restart the autonomous HO timer.

21. The apparatus of claim 18, wherein the circuitry determines that the HO command is received prior to the expiration of the autonomous HO timer, wherein the circuitry is further to identify an indication of a target eNB within the HO command, and wherein the HO operation comprises the UE establishing a connection with the target eNB.

22. One or more non-transitory, computer-readable media having instructions stored thereon, wherein the instructions, in response to execution by a user equipment (UE), cause the UE to:
identify an indication of one or more candidate evolved NodeBs (eNBs) within an autonomous handover (HO) information message received from a source eNB;
encode a measurement report for transmission to the source eNB after reception of the autonomous HO information message;
start an autonomous HO timer in response to the transmission of the measurement report;
determine whether an HO command is received prior to expiration of the autonomous HO timer; and
perform an HO operation, wherein the HO operation is dependent on whether the HO command is received prior to the expiration of the autonomous HO timer.

23. The one or more non-transitory, computer-readable media of claim 22, wherein the UE determines that the HO command is not received prior to the expiration of the autonomous HO timer, wherein the instructions further cause the UE to select a target eNB from the one or more candidate eNBs, and wherein the HO operation comprises the UE establishing a connection with the target eNB.

24. The one or more non-transitory, computer-readable media of claim 22, wherein the UE determines that the HO command is received prior to the expiration of the autonomous HO timer, wherein the instructions further cause the UE to identify an indication of a target eNB within the HO command, and wherein the HO operation comprises the UE establishing a connection with the target eNB.

25. The one or more non-transitory, computer-readable media of claim 22, wherein the instructions further cause UE to:
identify an indication that the UE is to restart the autonomous HO timer from a particular value within a subsequent autonomous HO information message received from the source eNB after transmission of the measurement report; and
restart the autonomous HO timer from the particular value in response to identification of the indication that the UE is to restart the autonomous HO timer.
